(19) United States
(12) Patent Application Publication
(10) Pub. No.: US 2020/0259673 A1
(43) Pub. Date: Aug. 13, 2020

(54) SHARED TERMINAL, SHARING SYSTEM, SHARING ASSISTING METHOD, AND NON-TRANSITORY COMPUTER-READABLE MEDIUM

(71) Applicant: Yoshiko AONO, Kanagawa (JP)

(72) Inventor: Yoshiko AONO, Kanagawa (JP)

(73) Assignee: Ricoh Company, Ltd.

(21) Appl. No.: 16/787,041

(22) Filed: Feb. 11, 2020

(30) Foreign Application Priority Data
Feb. 13, 2019 (JP) 2019-023618

(51) Int. Cl. H04L 12/18; G06F 3/0481; G06F 3/14

(52) U.S. Cl. CPC H04L 12/1818; H04L 12/1822; G10L 15/22; G06F 3/1454; G06F 3/0481

(57) ABSTRACT

A shared terminal communicable with a management system configured to manage content data generated in relation to an event includes a memory and circuitry. The memory stores one or more first applications, and a second application that activates the one or more first applications. The circuitry is configured to execute the second application to, receive selection of a particular first application of the one or more first applications, the particular first application being configured to perform processing to conduct a particular event, and send an event start request requesting to start the particular event to the particular first application. The circuitry is configured to execute the particular first application to perform processing to start the particular event identified by the event start request sent from the second application.

### CROSS-REFERENCE TO RELATED APPLICATION

This patent application is based on and claims priority pursuant to 35 U.S.C. § 119(a) to Japanese Patent Application No. 2019-023618, filed on Feb. 13, 2019, in the Japan Patent Office, the entire disclosure of which is hereby incorporated by reference herein.

### BACKGROUND

### Technical Field

The present disclosure relates to a shared terminal, a sharing system, a sharing assisting method, and a non-transitory computer-readable medium.

### Description of the Related Art

In recent years, shared terminals such as electronic whiteboards are widely used in companies, educational institutions or government institutions. The electronic whiteboards display a background image on a display and allows users to draw stroke images such as text, numbers, figures, or the like on the background image.

In some cases, an event such as a meeting is conducted using the electronic whiteboard, and an action log generated by the event is recorded in a server.

### SUMMARY

According to one or more embodiments, a shared terminal communicable with a management system configured to manage content data generated in relation to an event includes a memory and circuitry. The memory stores one or more first applications, and a second application that activates the one or more first applications. The circuitry is configured to execute the second application to, receive selection of a particular first application of the one or more first applications, the particular first application being configured to perform processing to conduct a particular event, and send an event start request requesting to start the particular event to the particular first application. The circuitry is configured to execute the particular first application to perform processing to start the particular event identified by the event start request sent from the second application.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an overview of a sharing system, according to an embodiment of the present disclosure;

FIG. 2 is a schematic block diagram illustrating a hardware configuration of an electronic whiteboard, according to an embodiment of the present disclosure;

FIG. 3 is a schematic block diagram illustrating a hardware configuration of a videoconference terminal, according to the embodiment of the present disclosure;

FIG. 4 is a schematic block diagram illustrating a hardware configuration of the car navigation system, according to the embodiment of the present disclosure;

FIG. 5 is a schematic block diagram illustrating a hardware configuration of a computer, such as a personal computer (PC), and a server, according to an embodiment of the present disclosure;

FIG. 6 is a schematic diagram illustrating a software configuration of the electronic whiteboard, according to an embodiment of the present disclosure;

FIG. 7 is a schematic diagram illustrating a software configuration of the PC, according to an embodiment of the present disclosure;

FIG. 8 is a schematic block diagram illustrating a functional configuration of a part of the sharing system illustrated in FIG. 1, according to an embodiment of the present disclosure;

FIG. 9A and FIG. 9B are schematic block diagrams illustrating a functional configuration of a part of the sharing system illustrated in FIG. 1, according to an embodiment of the present disclosure;

FIG. 10 is a conceptual diagram illustrating an application management table, according to an embodiment of the present disclosure;

FIG. 11A is a conceptual diagram illustrating a user authentication management table, according to an embodiment of the present disclosure;

FIG. 11B is a conceptual diagram illustrating an access management table, according to an embodiment of the disclosure;

FIG. 11C is a conceptual diagram illustrating a schedule management table, according to an embodiment of the present disclosure;

FIG. 12A is a conceptual diagram illustrating a conducted event management table, according to an embodiment of the present disclosure;

FIG. 12B is a conceptual diagram illustrating a content management table, according to an embodiment of the present disclosure;

FIG. 13A is a conceptual diagram illustrating a user authentication management table, according to an embodiment of the present disclosure;

FIG. 13B is a conceptual diagram illustrating a user management table, according to an embodiment of the present disclosure;

FIG. 13C is a conceptual diagram illustrating a resource management table, according to an embodiment of the present disclosure;

FIG. 14A is a conceptual diagram illustrating a resource reservation management table, according to an embodiment of the present disclosure;

FIG. 14B is a conceptual diagram illustrating an event management table, according to an embodiment of the present disclosure;

FIG. 15A is a conceptual diagram illustrating a server authentication management table, according to an embodiment of the present disclosure;

FIG. 15B is a conceptual diagram illustrating a project member management table, according to an embodiment of the present disclosure;

FIG. 16A is a conceptual diagram of a conducted event record management table, according to an embodiment of the present disclosure;

FIG. 16B is a conceptual diagram of a conducted event management table, according to an embodiment of the present disclosure;

FIG. 17 is a sequence diagram illustrating operation of registering a schedule, according to an embodiment of the present disclosure;

FIG. 18 is an illustration of an example of a sign-in screen, according to an embodiment of the present disclosure;

FIG. 19 is an illustration of an example of a menu screen displayed by the PC, according to an embodiment of the present disclosure;

FIG. 20 is an illustration of an example of a schedule input screen, according to an embodiment of the present disclosure;

FIG. 21A and FIG. 21B are sequence diagrams illustrating operation of controlling processing to start an event, according to an embodiment of the present disclosure;

FIG. 22 is an illustration of an example of a sign-in screen displayed on the electronic whiteboard, according to an embodiment of the present disclosure;

FIG. 23 is an illustration of an example of an application selection screen displayed on the electronic whiteboard, according to an embodiment of the present disclosure;

FIG. 24 is an illustration of an example of a reservation list screen of a resource, according to an embodiment of the present disclosure;

FIG. 25 is a sequence diagram illustrating operation of controlling processing to start an event, according to an embodiment of the present disclosure;

FIG. 26 is an illustration of an example of a project list screen, according to an embodiment of the present disclosure;

FIG. 27 is an illustration of an example of an event information screen, according to an embodiment of the present disclosure;

FIG. 28 is a sequence diagram illustrating operation of controlling processing to activate an external application, according to an embodiment of the present disclosure;

FIG. 29 is an illustration for explaining a use scenario of the electronic whiteboard, according to an embodiment of the present disclosure;

FIG. 30 is a sequence diagram illustrating operation of registering a record of an event that has been started, according to an embodiment, according to an embodiment of the present disclosure;

FIG. 31 is a flowchart illustrating operation of converting voice data to text data, according to an embodiment, according to an embodiment of the present disclosure;

FIG. 32 is a sequence diagram illustrating operation of registering a record of an event that has been started, according to an embodiment, according to an embodiment of the present disclosure;

FIG. 33 is a flowchart illustrating operation of registering an action item, according to an embodiment of the present disclosure;

FIG. 34 is an illustration of an example screen in which an action item is designated, according to an embodiment of the present disclosure;

FIG. 35 is an illustration of an example of a screen including a list of candidates of owner of the action item, according to an embodiment of the present disclosure;

FIG. 36 is an illustration of an example of a screen including a calendar for selecting the due date of the action item, according to an embodiment of the present disclosure;

FIG. 37 is a sequence diagram illustrating operation of controlling processing to end an event, according to an embodiment of the present disclosure;

FIG. 38 is a sequence diagram illustrating operation of controlling processing to end an event, according to an embodiment of the present disclosure;

FIG. 39 is an illustration of an example of an event end screen, displayed by the electronic whiteboard, according to an embodiment of the present disclosure;

FIG. 40 is an illustration of an example of a file data uploading screen, displayed by the electronic whiteboard, according to an embodiment of the present disclosure; and

FIG. 41 is an illustration of an example of a file data uploading completion screen, displayed by the electronic whiteboard, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring to the drawings, a system for sharing one or more resources (“sharing system”) is described according to one or more embodiments. In this disclosure, an “electronic file” may be referred to as a “file”.

Overview of System Configuration:

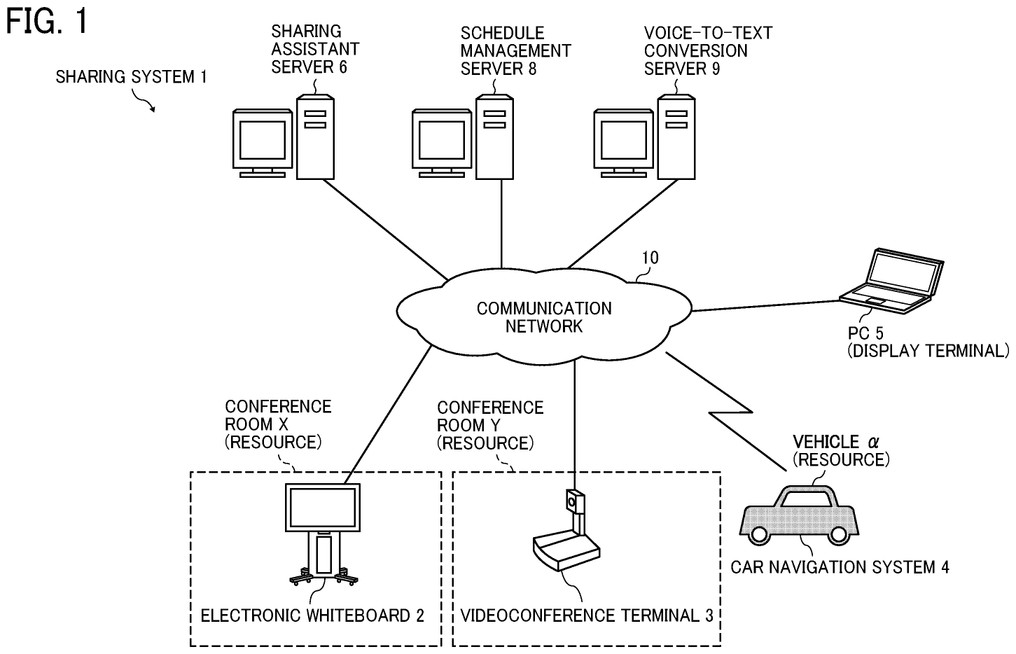

First, an overview of a configuration of a sharing system 1 is described. FIG. 1 is a schematic diagram illustrating an overview of the sharing system 1 according to one or more embodiments.

As illustrated in FIG. 1, the sharing system 1 of the embodiment includes an electronic whiteboard 2, a videoconference terminal 3, a car navigation system 4, a personal computer (PC) 5, a sharing assistant server 6, a schedule management server 8, and a voice-to-text conversion server 9.

The electronic whiteboard 2, the videoconference terminal 3, the car navigation system 4, the PC 5, the sharing assistant server 6, the schedule management server 8, and the voice-to-text conversion server 9 are communicable with one another via a communication network 10. The communication network 10 is implemented by the Internet, a mobile communication network, a local area network (LAN), etc. The communication network 10 may include, in addition to a wired network, a wireless network in compliance with such as 3rd Generation (3G), Worldwide Interoperability for Microwave Access (WiMAX), Long Term Evolution (LTE), etc.

In this example, the electronic whiteboard 2 is provided in a conference room X. The videoconference terminal 3 is provided in a conference room Y. Further, in this disclosure, a resource may be shared among a plurality of users, such that any user is able to reserve any resource. Accordingly, the resource can be a target for reservation by each user. The car navigation system 4 is provided in a vehicle a. In this case, the vehicle a is a vehicle shared among a plurality of users, such as a vehicle used for car sharing. Further, the vehicle could be any means capable of transporting the human-being from one location to another location. Examples of vehicle include, but not limited to, cars, motorcycles, bicycles, and wheelchairs.

Examples of the resource include, but not limited to, any object, service, space or place (room, or a part of room), information (data), which can be shared among a plurality of users. Further, the user may be an individual person, a group of persons, or an organization such as a company. In the sharing system 1 illustrated in FIG. 1, the conference room X, the conference room Y, and the vehicle a are examples of a resource shared among a plurality of users. Examples of information as a resource include, but not limited to, information on an account assigned to the user, with the user being more than one individual person. For example, the organization may only be assigned with one account that allows any user in the organization to use a specific service provided on the Internet. In such case, information on such account, such as a user name and a password, is assumed to be a resource that can be shared among a plurality of users in that organization. In one example, the teleconference or videoconference service may be provided via the Internet, which may be provided to a user who has logged in with a specific account.

The electronic whiteboard 2, the videoconference terminal 3, and the car navigation system 4, are each an example of a shared terminal. The shared terminal is any device capable of communicating with such as the sharing assistant server 6 and the schedule management server 8, and providing information obtained from the server to the user of the resource. Examples of the shared terminal provided in the vehicle a may not only include the car navigation system 4, but also a smartphone or a smartwatch installed with such as a car navigation application.

The PC 5 is an example a display terminal. Specifically, the PC 5 is an example of a registration apparatus that registers, to the schedule management server 8, reservations made by each user to use each resource, or any event scheduled by each user. Examples of the event include, but not limited to, a conference, meeting, gathering, counseling, lecture, presentation, driving, ride, and transporting.

The sharing assistant server 6, which is implemented by one or more computers, assists in sharing of a resource among the users, for example, via the shared terminal.

The schedule management server 8, which is implemented by one or more computers, manages reservations for using each resource and schedules of each user.

The voice-to-text conversion server 9, which is implemented by one or more computers, converts voice data (example of audio data) received from an external computer (for example, the sharing assistant server 6), into text data.

The sharing assistant server 6, the schedule management server 8, and the voice-to-text conversion server 9 may be collectively referred to as a “control system”. The control system may be, for example, a server that performs all or a part of functions of the sharing assistant server 6, the schedule management server 8, and the voice-to-text conversion server 9.

Hardware Configuration:

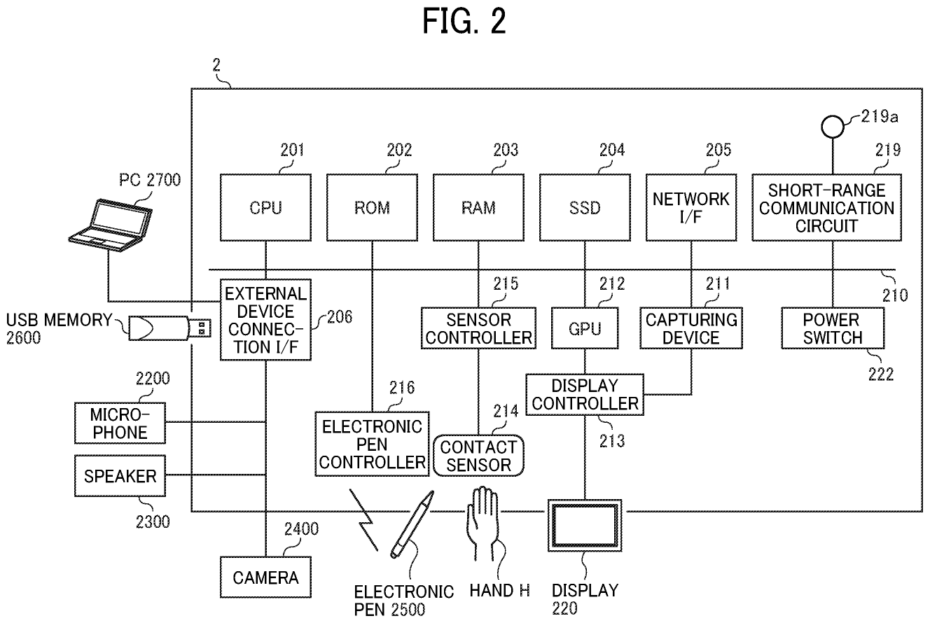

Referring to FIG. 2 to FIG. 5, a hardware configuration of the apparatus or terminal in the sharing system 1 is described according to the embodiment.

Hardware Configuration of Electronic Whiteboard:

FIG. 2 is a schematic block diagram illustrating a hardware configuration of the electronic whiteboard 2, according to the embodiment. As illustrated in FIG. 2, the electronic whiteboard 2 includes a central processing unit (CPU) 201, a read only memory (ROM) 202, a random access memory (RAM) 203, a solid state drive (SSD) 204, a network interface (I/F) 205, and an external device connection interface (I/F) 206.

The CPU 201 controls entire operation of the electronic whiteboard 2. The ROM 202 stores a control program such as an Initial Program Loader (IPL) to boot the CPU 201. The RAM 203 is used as a work area for the CPU 201. The SSD 204 stores various data such as the control program for the electronic whiteboard 2. The network I/F 205 controls communication with an external device through the communication network 10. The external device connection I/F 206 controls communication with a universal serial bus (USB) memory 2600, a PC 2700, and external devices (a microphone 2200, a speaker 2300, and a camera 2400).

The electronic whiteboard 2 further includes a capturing device 211, a graphics processing unit (GPU) 212, a display controller 213, a contact sensor 214, a sensor controller 215, an electronic pen controller 216, a short-range communication circuit 219, an antenna 219a for the short-range communication circuit 219, and a power switch 222.

The capturing device 211 acquires image data of an image displayed on a display 220 under control of the display controller 213, and stores the image data in the RAM 203 or the like. The display 220 is an example of a display unit. The GPU 212 is a semiconductor chip dedicated to processing of a graphical image. The display controller 213 controls display of an image processed at the capturing device 211 or the GPU 212 for output through the display 220 provided with the electronic whiteboard 2. The contact sensor 214 detects a touch onto the display 220 with an electronic pen (stylus pen) 2500 or a user's hand H. The sensor controller 215 controls operation of the contact sensor 214. The contact sensor 214 senses a touch input to a specific coordinate on the display 220 using the infrared blocking system. More specifically, the display 220 is provided with two light receiving elements disposed on both upper side ends of the display 220, and a reflector frame surrounding the sides of the display 220. The light receiving elements emit a plurality of infrared rays in parallel to a surface of the display 220. The light receiving elements receive lights passing in the direction that is the same as an optical path of the emitted infrared rays, which are reflected by the reflector frame. The contact sensor 214 outputs an identifier (ID) of the infrared ray that is blocked by an object (such as the user's hand) after being emitted from the light receiving elements, to the sensor controller 215. Based on the ID of the infrared ray, the sensor controller 215 detects a specific coordinate that is touched by the object. The electronic pen controller 216 communicates with the electronic pen 2500 to detect a touch by the tip or bottom of the electronic pen 2500 to the display 220. The short-range communication circuit 219 is a communication circuit that communicates in compliance with the near field communication (NFC) (Registered Trademark), the Bluetooth (Registered Trademark), and the like. The power switch 222 turns on or off the power of the electronic whiteboard 2.

The electronic whiteboard 2 further includes a bus line 210. The bus line 210 is an address bus or a data bus, which electrically connects the elements in FIG. 2 such as the CPU 201.

The contact sensor 214 is not limited to the infrared blocking system type, and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. In addition to or in alternative to detecting a touch by the tip or bottom of the electronic pen 2500, the electronic pen controller 216 may also detect a touch by another part of the electronic pen 2500, such as a part held by a hand of the user.

Hardware Configuration of Videoconference Terminal:

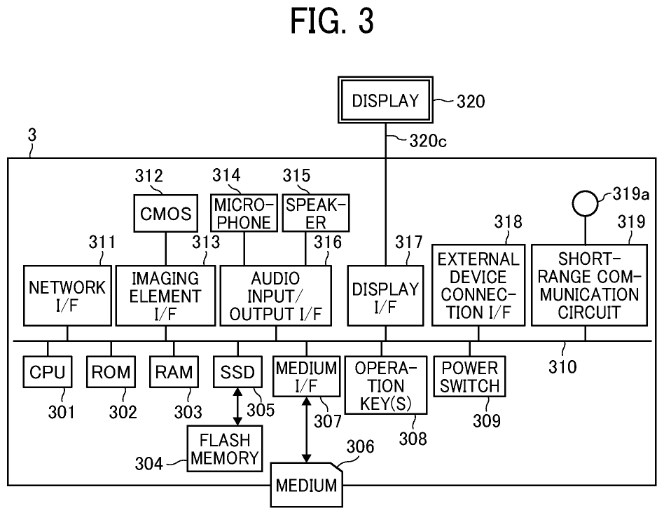

FIG. 3 is a schematic block diagram illustrating a hardware configuration of the videoconference terminal 3, according to the embodiment. As illustrated in FIG. 3, the videoconference terminal 3 includes a CPU 301, a ROM 302, a RAM 303, a flash memory 304, a SSD 305, a medium I/F 307, an operation key 308, a power switch 309, a bus line 310, a network I/F 311, a complementary metal oxide semiconductor (CMOS) sensor 312, an imaging element I/F 313, a microphone 314, a speaker 315, an audio input/output I/F 316, a display I/F 317, an external device connection I/F 318, a short-range communication circuit 319, and an antenna 319a for the short-range communication circuit 319. The CPU 301 controls entire operation of the videoconference terminal 3. The ROM 302 stores a control program such as an IPL to boot the CPU 301. The RAM 303 is used as a work area for the CPU 301. The flash memory 304 stores various data such as a communication control program, image data, and audio data. The SSD 305 controls reading or writing of various data with respect to the flash memory 304 under control of the CPU 301. In alternative to the SSD, a hard disk drive (HDD) may be used. The medium I/F 307 controls reading or writing of data with respect to a storage medium 306 such as a flash memory. The operation key (keys) 308 is operated by a user to input a user instruction such as a user selection of a communication destination of the videoconference terminal 3. The power switch 309 is a switch that receives an instruction to turn on or off the power of the videoconference terminal 3.

The network I/F 311 in an interface that controls communication of data between the videoconference terminal 3 and an external device through the communication network 10 such as the Internet. The CMOS sensor 312 is an example of a built-in imaging device configured to capture a subject under control of the CPU 301 to obtain image data. The imaging element I/F 313 is a circuit that controls driving of the CMOS sensor 312. The microphone 314 is an example of built-in audio collecting device configured to input audio under control of the CPU 301. The audio input/output I/F 316 is a circuit for inputting or outputting an audio signal to the microphone 314 or from the speaker 315 under control of the CPU 301. The display I/F 317 is a circuit for transmitting display data to an external display 320 under control of the CPU 301. The external device connection I/F 318 is an interface circuit that connects the videoconference terminal 3 to various external devices. The short-range communication circuit 319 is a communication circuit that communicates in compliance with the NFC, the Bluetooth, and the like.

The bus line 310 is an address bus or a data bus, which electrically connects the elements in FIG. 3 such as the CPU 301.

The display 320 is an example of a display device that displays an image of a subject, an operation icon or the like. The display 320 is configured as a liquid crystal display or an organic electroluminescence (EL) display, for example. The display 320 is connected to the display I/F 317 by a cable 320c. The cable 320c may be an analog red green blue (RGB) (video graphic array (VGA)) signal cable, a component video cable, a DisplayPort signal cable, a high-definition multimedia interface (HDMI) (registered trademark) signal cable, or a digital video interactive (DVI) signal cable.

In alternative to the CMOS sensor 312, an imaging element such as a CCD (Charge Coupled Device) sensor may be used. The external device connection I/F 318 is configured to connect an external device such as an external camera, an external microphone, or an external speaker through a USB cable or the like. In the case where an external camera is connected, the external camera is driven in preference to the built-in CMOS sensor 312 under control of the CPU 301. Similarly, in the case where an external microphone is connected or an external speaker is connected, the external microphone or the external speaker is driven in preference to the built-in microphone 314 or the built-in speaker 315 under control of the CPU 301.

The storage medium 306 is removable from the videoconference terminal 3. The storage medium 306 can be any nonvolatile memory that reads or writes data under control of the CPU 301, such that any memory such as an EEPROM may be used instead of the flash memory 304.

Hardware Configuration of Car Navigation System:

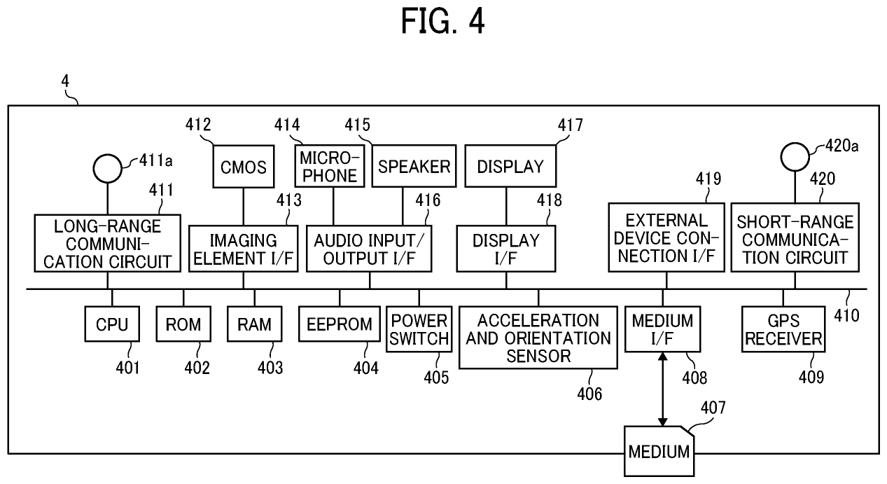

FIG. 4 is a schematic block diagram illustrating a hardware configuration of the car navigation system 4, according to the embodiment. As illustrated in FIG. 4, the car navigation system 4 includes a CPU 401, a ROM 402, a RAM 403, an EEPROM 404, a power switch 405, an acceleration and orientation sensor 406, a medium I/F 408, and a global positioning system (GPS) receiver 409.

The CPU 401 controls entire operation of the car navigation system 4. The ROM 402 stores a control program such as an IPL to boot the CPU 401. The RAM 403 is used as a work area for the CPU 401. The EEPROM 404 reads or writes various data such as a control program for the car navigation system 4 under control of the CPU 401. The power switch 405 turns on or off the power of the car navigation system 4. The acceleration and orientation sensor 406 includes various sensors such as an electromagnetic compass for detecting geomagnetism, a gyrocompass, and an acceleration sensor. The medium I/F 408 controls reading or writing of data with respect to a storage medium 407 such as a flash memory. The GPS receiver 409 receives a GPS signal from a GPS satellite.

The car navigation system 4 further includes a long-range communication circuit 411, an antenna 411a for the long-range communication circuit 411, a CMOS sensor 412, an imaging element I/F 413, a microphone 414, a speaker 415, an audio input/output I/F 416, a display 417, a display I/F 418, an external device connection I/F 419, a short-range communication circuit 420, and an antenna 420a for the short-range communication circuit 420.

The long-range communication circuit 411 is a circuit, which receives traffic jam information, road construction information, traffic accident information and the like provided from an infrastructure system external to the vehicle, and transmits information on the location of the vehicle, life-saving signals, etc. back to the infrastructure system in the case of emergency. The infrastructure system external to the vehicle includes a road information guidance system such as Vehicle Information and Communication System (VICS) (registered trademark), for example. The CMOS sensor 412 is an example of a built-in imaging device configured to capture a subject under control of the CPU 401 to obtain image data. The imaging element I/F 413 is a circuit that controls driving of the CMOS sensor 412. The microphone 414 is an example of built-in audio collecting device configured to input audio under control of the CPU 401. The audio input/output I/F 416 is a circuit for inputting or outputting an audio signal between the microphone 414 and the speaker 415 under control of the CPU 401. The display 417 is an example of a display device (display means) that displays an image of a subject, an operation icon, or the like. The display 417 is configured as a liquid crystal display or an organic EL display, for example. The display 417 has a function of a touch panel. The touch panel is an example of an input device (input means) that enables the user to input a user instruction for operating the car navigation system 4 through touching a screen of the display 417. The display I/F 418 is a circuit that controls the display 417 to display an image. The external device connection I/F 419 is an interface circuit that connects the car navigation system 4 to various external devices. The short-range communication circuit 420 is a communication circuit that communicates in compliance with the NFC, the Bluetooth, and the like. The car navigation system 4 further includes a bus line 410. The bus line 410 is an address bus or a data bus, which electrically connects the elements in FIG. 4 such as the CPU 401.

Hardware Configuration of Server and PC:

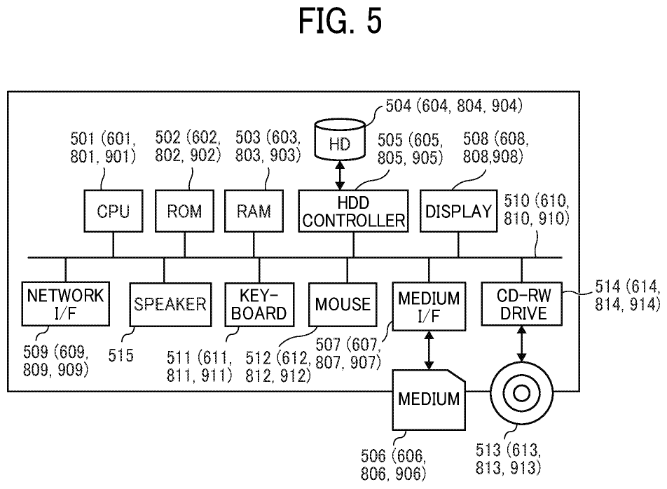

FIG. 5 is a diagram illustrating a hardware configuration of the server (such as the sharing assistant server 6 and the schedule management server 8) and the PC 5, according to the embodiment. The PC 5 is configured as a general-purpose computer. As illustrated in FIG. 5, the PC 5 includes a CPU 501, a ROM 502, a RAM 503, a hard disk (HD) 504, an HDD controller 505, a medium I/F 507, a display 508, a network I/F 509, a keyboard 511, a mouse 512, a compact disc rewritable (CD-RW) drive 514, a speaker 515, and a bus line 510. The CPU 501 controls entire operation of the PC 5. The ROM 502 stores a control program such as an IPL to boot the CPU 501. The RAM 503 is used as a work area for the CPU 501. The HD 504 stores various data such as a control program. The HDD controller 505 controls reading or writing of various data to or from the HD 504 under control of the CPU 501. The medium I/F 507 controls reading or writing of data with respect to a storage medium 506 such as a flash memory. The display 508 displays various information such as a cursor, menu, window, characters, or image. The network I/F 509 is an interface that controls communication of data with an external device through the communication network 10. The keyboard 511 is one example of an input device (input means) provided with a plurality of keys for enabling a user to input characters, numerals, or various instructions. The mouse 512 is one example of an input device (input means) for enabling the user to select a specific instruction or execution, select a target for processing, or move a cursor being displayed. The CD-RW drive 514 reads or writes various data with respect to a CD-RW 513, which is one example of a removable storage medium. The speaker 515 outputs a sound signal under control of the CPU 501.

The bus line 510 may be an address bus or a data bus, which electrically connects various elements such as the CPU 501 of FIG. 5.

Still referring to FIG. 5, a hardware configuration of each of the sharing assistant server 6, the schedule management server 8 and the voice-to-text conversion server 9 is described. As illustrated in FIG. 5, the sharing assistant server 6, which is implemented by a general-purpose computer, includes a CPU 601, a ROM 602, a RAM 603, an HD 604, an HDD controller 605, a medium I/F 607, a display 608, a network I/F 609, a keyboard 611, a mouse 612, a CD-RW drive 614, and a bus line 610. The sharing assistant server 6 may be provided with a storage medium 606 or a CD-RW 613. Since these elements are substantially similar to the CPU 501, the ROM 502, the RAM 503, the HD 504, the HDD controller 505, the storage medium 506, the medium I/F 507, the display 508, the network I/F 509, the keyboard 511, the mouse 512, the CD-RW drive 514, and bus line 510 of the PC 5, redundant description thereof is omitted.

Referring to FIG. 5, the schedule management server 8, which is implemented by a general-purpose computer, includes a CPU 801, a ROM 802, a RAM 803, a HD 804, an HDD controller 805, a medium I/F 807, a display 808, a network I/F 809, a keyboard 811, a mouse 812, a CD-RW drive 814, and a bus line 810. The schedule management server 8 may be provided with a storage medium 806 or a CD-RW 813. Since these elements are substantially similar to the CPU 501, the ROM 502, the RAM 503, the HD 504, the HDD controller 505, the storage medium 506, the medium I/F 507, the display 508, the network I/F 509, the keyboard 511, the mouse 512, the CD-RW drive 514, and the bus line 510 of the PC 5, redundant description thereof is omitted.

As illustrated in FIG. 5, the voice-to-text conversion server 9, which is implemented by a general-purpose computer, includes a CPU 901, a ROM 902, a RAM 903, an HD 904, an HDD controller 905, a medium I/F 907, a display 908, a network I/F 909, a keyboard 911, a mouse 912, a CD-RW drive 914, and a bus line 910. The voice-to-text conversion server 9 may be provided with a storage medium 906 or a CD-RW 913. Since these elements are substantially similar to the CPU 501, the ROM 502, the RAM 503, the HD 504, the HDD controller 505, the storage medium 506, the medium I/F 507, the display 508, the network I/F 509, the keyboard 511, the mouse 512, the CD-RW drive 514, and the bus line 510 of the PC 5, redundant description thereof is omitted.

Further, any one of the above-described control programs may be recorded in a file in a format installable or executable on a computer-readable storage medium for distribution. Examples of the storage medium include, but not limited to, Compact Disc Recordable (CD-R), Digital Versatile Disc (DVD), blue-ray disc, and SD card. In addition, such storage medium may be provided in the form of a program product to users within a certain country or outside that country. For example, the shared terminal such as the electronic whiteboard 2 executes the program according to the present disclosure to implement a sharing assist method according to the present disclosure.

The sharing assistant server 6 may be configured by a single computer or a plurality of computers to which divided portions (functions, means, or storages) are arbitrarily allocated. This also applies to the schedule management server 8 and the voice-to-text conversion server 9.

Software Configuration of Electronic Whiteboard:

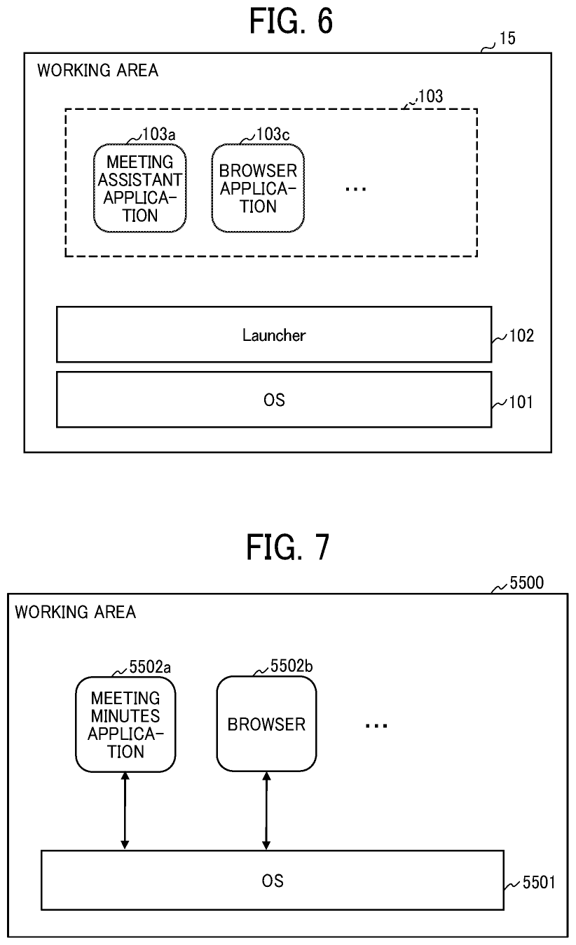

Next, referring to FIG. 6, computer software to be installed to the electronic whiteboard 2 is described according to an embodiment. In this disclosure, computer software (hereinafter simply referred to as “software”) is a program relating to operation to be performed by a computer or any data to be used in processing by a computer according to such program. The program is a set of instructions for causing the computer to perform processing to have a certain result. While data to be used in processing according to the program is not a program itself, such data may define processing to be performed by the program such that it may be interpreted as equivalent to the program. For example, a data structure, which is a logical structure of data described by an interrelation between data elements, may be interpreted as equivalent to the program.

The application program, which may be simply referred to as “application”, is a general term for any software used to perform certain processing. The operating system (hereinafter simply referred to as an “OS”) is software for controlling a computer, such that software, such as application, is able to use computer resource. The OS controls basic operation of the computer such as input or output of data, management of hardware such as a memory or a hard disk, or processing to be executed. The application controls processing using functions provided by the OS.

FIG. 6 is a schematic diagram illustrating a software configuration of the electronic whiteboard 2, according to an embodiment. As illustrated in FIG. 6, the electronic whiteboard 2 is installed with OS 101, Launcher 102, meeting assistant application 103a, and browser application 103c, which operate on a work area 15 of the RAM 203. The OS 101 is basic software that controls entire operation of the electronic whiteboard 2 through providing basic functions.

The Launcher 102 operates on the OS 101. The Launcher 102 controls, for example, processing to start or end an event managed by the electronic whiteboard 2, or controls application such as the meeting assistant application 103a and the browser application 103c, which may be used during the event being conducted. In the following, one example of event is a meeting. The Launcher 102 is an example of a second application.

In this example, the meeting assistant application 103a and the browser application 103c are external applications, each operating on the Launcher 102. Hereinafter, the meeting assistant application 103a and the browser application 103c are collectively referred to as “external application 103”, unless they have to be distinguished from each other. The external application 103 executes processing independently of the Launcher 102 to execute a service or a function under control of the OS 101. Although FIG. 6 illustrates an example in which two external applications, i.e., the meeting assistant application 103a and the browser application 103c are installed on the electronic whiteboard 2, any number of external applications may be installed on the electronic whiteboard. The external application 103 is an example of a first application.

The Launcher 102 installed on the electronic whiteboard 2 can be any launcher application operating on the OS 101. Since the electronic whiteboard 2 is a shared terminal as described above, a launcher application having a user interface that is easy for a plurality of users to use is installed on the electronic whiteboard 2. The electronic whiteboard 2 executes an event registered in the schedule management server 8 by controlling the desired launcher application and the external application 103 to operate in cooperation with each other.

Software Configuration of PC:

Next, referring to FIG. 7, computer software to be installed to the PC 5 is described according to an embodiment. FIG. 7 is a schematic diagram illustrating a software configuration of the PC 5, according to the embodiment. As illustrated in FIG. 7, the PC 5 is installed with OS 5501, meeting minutes application 5502a, and browser application 5502b, which operate on a working area 5500 of the RAM 503. The OS 5501 is basic software that controls entire operation of the PC 5 through providing basic functions.

The meeting minutes application 5502a, in cooperation with the browser application 5502b, generates and displays an event record screen, which functions as meeting minutes of one or more meetings conducted using the electronic whiteboard 2, for example, based on various data transmitted from the schedule management server 8. Although FIG. 7 illustrates an example in which two external applications, i.e., the meeting minutes application 5502a and the browser application 5502b, are installed on the PC 5, any number of external applications may be installed on the PC 5.

Functional Configuration of Sharing System:

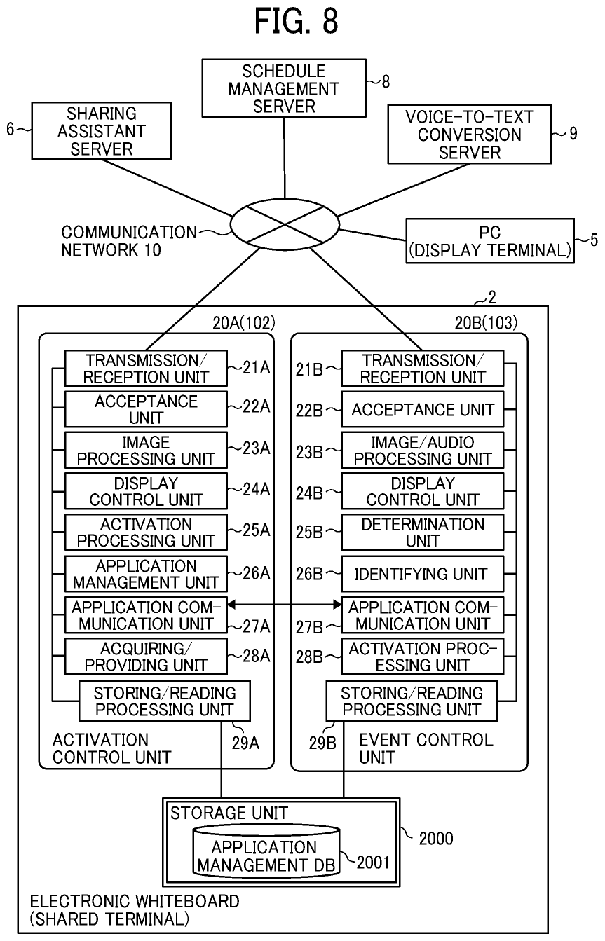

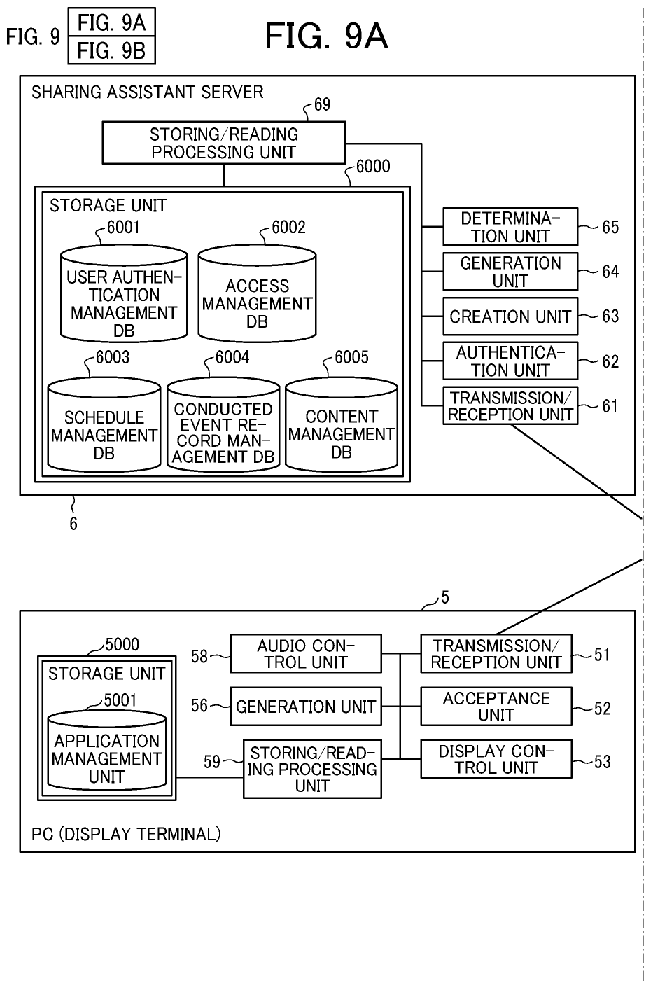

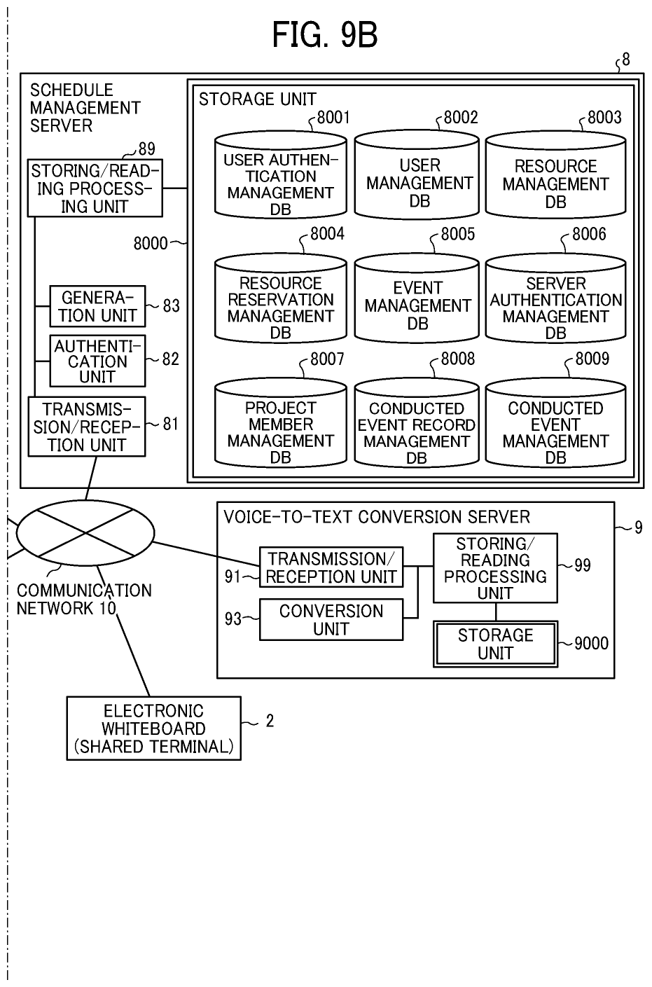

Referring to FIG. 8 to FIG. 16, a functional configuration of the sharing system 1 is described according to the embodiment. FIG. 8, FIG. 9A, and FIG. 9B are block diagrams illustrating a functional configuration of the sharing system 1. In FIG. 8, FIG. 9A, and FIG. 9B, only a part of those terminals, devices, and servers illustrated in FIG. 1 is illustrated, which relates to processing or operation to be described below. More specifically, the following illustrates an example case in which the user uses the conference room X as a resource, in which the electronic whiteboard 2 is provided. In other words, the videoconference terminal 3 and the car navigation system 4 do not have to be provided in the following embodiment.

Functional Configuration of Electronic Whiteboard:

As illustrated in FIG. 8, the electronic whiteboard 2 includes an activation control unit 20A and an event control unit 20B. The activation control unit 20A is implemented by execution of the Launcher 102 illustrated in FIG. 6. The event control unit 20B is implemented by execution of the external application 103 illustrated in FIG. 6. These units are functions that are implemented by or that are caused to function by operating any of the elements illustrated in FIG. 2 in cooperation with the instructions of the CPU 201 according to the electronic whiteboard control program read from the SSD 204 to the RAM 203. The electronic whiteboard 2 further includes a storage unit 2000, which is implemented by the RAM 203, the SSD 204, or the USB memory 2600 illustrated in FIG. 2.

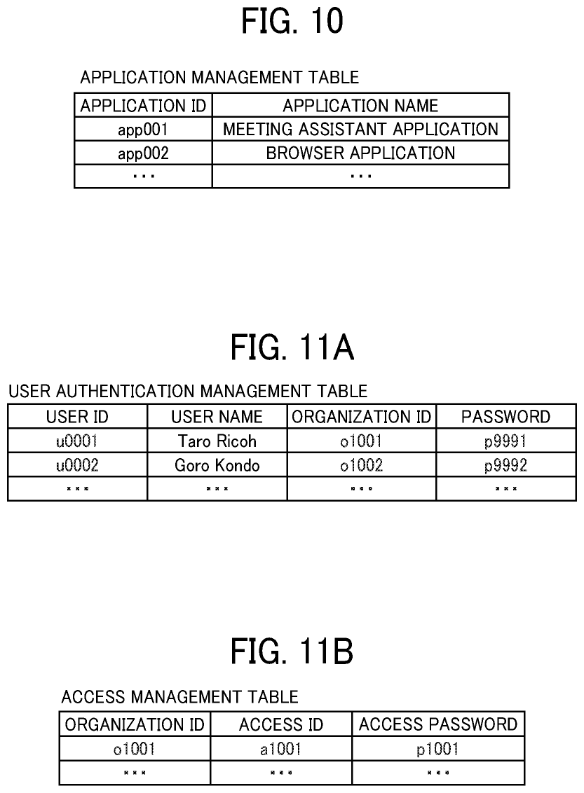

Application Management Table: FIG. 10 is an illustration of an example data structure of an application management table. The storage unit 2000 stores an application management database (DB) 2001, which is implemented by the application management table as illustrated in FIG. 10. The application management table stores one or more application IDs each identifying the external application 103 installed in the shared terminal such as the electronic whiteboard 2, and names of the one or more external applications 103, in association.

Functional Unit of Electronic Whiteboard: Next, each functional unit of the electronic whiteboard 2 is described according to the embodiment. First, the activation control unit 20A, which is implemented by the Launcher 102, includes a transmission/reception unit 21A, an acceptance unit 22A, an image processing unit 23A, a display control unit 24A, an activation processing unit 25A, an application management unit 26A, an application communication unit 27A, an acquiring/providing unit 28A and a storing/reading processing unit 29A.

The transmission/reception unit 21A, which is implemented by the instructions of the CPU 201, by the network I/F 205, and by the external device connection I/F 206 illustrated in FIG. 2, transmits or receives various data (or information) to or from other terminal, apparatus, or system through the communication network 10. The transmission/reception unit 21A is an example of first receiving means.

The acceptance unit 22A, which is implemented by the instructions of the CPU 201, by the contact sensor 214, and by the electronic pen controller 216 illustrated in FIG. 2, receives various inputs from the user. The acceptance unit 22A is an example of accepting means.

In example operation, the image processing unit 23A, which may be implemented by the instructions of the CPU 201 and the capturing device 211 illustrated in FIG. 2, captures and stores image data displayed on the display 220. In other operation, the image processing unit 23A, which may be implemented by the instructions of the CPU 201 and the GPU 212 illustrated in FIG. 2, performs processing on data to be displayed on the display 220.

The display control unit 24A is implemented by the instructions of the CPU 201 and by the display controller 213 illustrated in FIG. 2. The display control unit 24A controls the display 220 to display a drawing image, or accesses the sharing assistant server 6 using the web browser to display various screen data. Specifically, the display control unit 24A activates and executes the Launcher 102, which operates on the OS 101 illustrated in FIG. 6, to display various screens on the display 220, under control of an API (Application Programming Interface) of the OS 101. The display control unit 24A is an example of first display control means.

The activation processing unit 25A, which is implemented by the instructions of the CPU 201 illustrated in FIG. 2, activates the Launcher 102.

The application management unit 26A, which is implemented by the instructions of the CPU 201 illustrated in FIG. 2, controls the external application 103, which operates on the Launcher 102.

The application communication unit 27A, which is implemented by the instructions of the CPU 201 illustrated in FIG. 2, communicates various data (information) with the external application 103. The application communication unit 27A is an example of notification sending means.

The acquiring/providing unit 28A, which is implemented by the instructions of the CPU 201 and by the short-range communication circuit 219 with the antenna 219a illustrated in FIG. 2, communicates with a terminal device carried by the user, such as an IC card or a smartphone to obtain or provide data from or to the IC card or the smartphone by short-range communication.

The storing/reading processing unit 29A, which is implemented by the instructions of the CPU 201 and the SSD 204, illustrated in FIG. 2, performs processing to store various types of data in the storage unit 2000 or read various types of data stored in the storage unit 2000. Further, every time image data and audio data are received in performing communication with other electronic whiteboard or videoconference terminal, the storing/reading processing unit 29A overwrites data in the storage unit 2000 with the received image data and audio data. The display 220 displays an image based on image data before being overwritten, and the speaker 2300 outputs audio based on audio data before being overwritten.

The event control unit 20B, which is implemented by the external application 103, includes a transmission/reception unit 21B, an acceptance unit 22B, an image/audio processing unit 23B, a display control unit 24B, a determination unit 25B, an identifying unit 26B, an application communication unit 27B, an activation processing unit 28B, and a storing/reading processing unit 29B.

The transmission/reception unit 21B, which is implemented by the instructions of the CPU 201, by the network I/F 205, and by the external device connection I/F 206 illustrated in FIG. 2, transmits or receives various data (or information) to or from other terminal, apparatus, or system through the communication network 10. The transmission/reception unit 21B is an example of first transmitting means.

The acceptance unit 22B, which is implemented by the instructions of the CPU 201, by the contact sensor 214, and by the electronic pen controller 216 illustrated in FIG. 2, receives various inputs from the user.

In example operation, the image/audio processing unit 23B, which may be implemented by the instructions of the CPU 201 and the capturing device 211 illustrated in FIG. 2, captures and stores image data displayed on the display 220. In other operation, the image/audio processing unit 23B, which may be implemented by the instructions of the CPU 201 and the GPU 212 illustrated in FIG. 2, performs processing on data to be displayed on the display 220. For example, the image/audio processing unit 23B applies image processing to image data of a subject that has been captured by the camera 2400. After voice sound generated by a user is converted to audio signals by the microphone 2200, the image/audio processing unit 23B applies audio processing to audio data corresponding to the audio signals. Further, the image/audio processing unit 23B outputs the audio signal according to the audio data to the speaker 2300, and the speaker 2300 outputs sounds. In another example, the image/audio processing unit 23B obtains drawing image data, data of an image drawn by the user with the electronic pen 2500 or the user's hand H onto the display 220, and converts the drawing image data to coordinate data. For example, when the electronic whiteboard 2 transmits the coordinate data to an electronic whiteboard 2 at another site, the electronic whiteboard 2 at the another site controls the display 220 of the electronic whiteboard 2 at the another site to display a drawing image having the same content based on the received coordinate data. The image/audio processing unit 23B is an example of generating means.

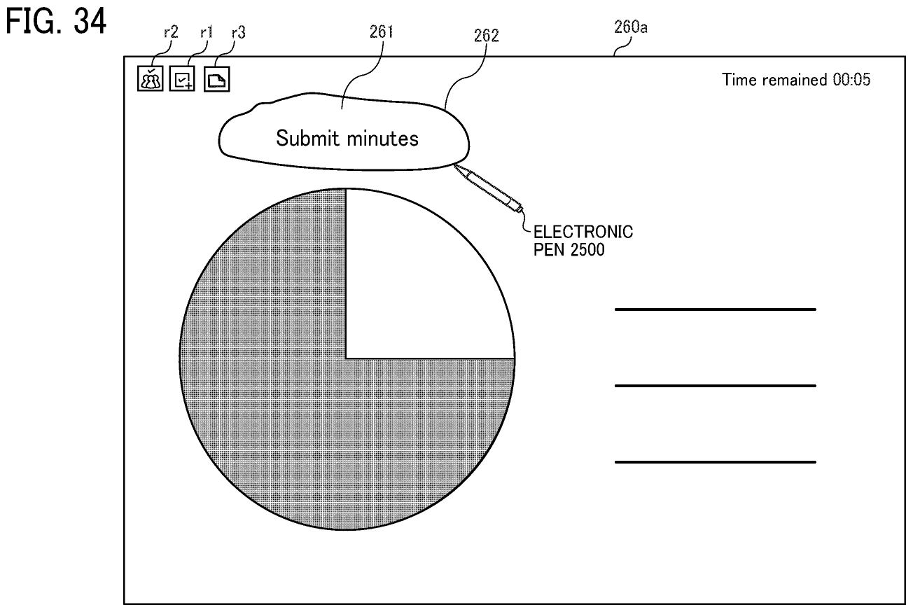

The display control unit 24B is implemented by the instructions of the CPU 201 and by the display controller 213 illustrated in FIG. 2. The display control unit 24A controls the display 220 to display a drawing image, or accesses the sharing assistant server 6 using the web browser to display various screen data. Specifically, the display control unit 24B activates and executes the external application 103, which operates on the OS 101 illustrated in FIG. 6, to display various screens on the display 220, under control of an API of the OS 101. The display control unit 24B is an example of second display control means. The determination unit 25B, which may be implemented by the instructions of the CPU 201 illustrated in FIG. 2, outputs a determination result. The identifying unit 26B, which may be implemented by the instructions of the CPU 201 illustrated in FIG. 2, identifies a designated area 262 on a screen of the display 220. A description of the designated area 262 is given below with reference to FIG. 34.

The application communication unit 27B, which is implemented by the instructions of the CPU 201 illustrated in FIG. 2, communicates various data (information) with the Launcher 102.

The activation processing unit 28B, which is implemented by the instructions of the CPU 201 illustrated in FIG. 2, activates the external application 103. The activation processing unit 28B is an example of event executing means.

The storing/reading processing unit 29B, which is implemented by the instructions of the CPU 201 and by the SSD 204 illustrated in FIG. 2, performs processing to store various types of data in the storage unit 2000 or read various types of data stored in the storage unit 2000. Further, every time image data and audio data are received in performing communication with other electronic whiteboard or videoconference terminal, the storing/reading processing unit 29B overwrites data in the storage unit 2000 with the received image data and audio data. The display 220 displays an image based on image data before being overwritten, and the speaker 2300 outputs audio based on audio data before being overwritten.

Functional Configuration of PC:

As illustrated in FIG. 9A, the PC 5 includes a transmission/reception unit 51, an acceptance unit 52, a display control unit 54, a generation unit 56, an audio control unit 58, and a storing/reading processing unit 59. These units are functions that are implemented by or that are caused to function by operating any of the elements illustrated in FIG. 5 in cooperation with the instructions of the CPU 501 according to the control program expanded from the HD 504 to the RAM 503. The PC 5 further includes a storage unit 5000 implemented by the HD 504 illustrated in FIG. 5.

Functional Unit of PC: Next, each functional unit of the PC 5 is described according to the embodiment. The transmission/reception unit 51, which is implemented by the instructions of the CPU 501 and by the network I/F 509 illustrated in FIG. 5, transmits or receives various types of data (or information) to or from other terminal, device, apparatus, or system through the communication network 10.

The acceptance unit 52, which is implemented by the instructions of the CPU 501, by the keyboard 511, and by the mouse 512 illustrated in FIG. 5, accepts various inputs from the user.

The display control unit 54, which is implemented by the instructions of the CPU 501 illustrated in FIG. 5, controls the display 508 to display an image, for example, using web browser based on various screen data that is obtained through accessing the sharing assistant server 6. Specifically, the display control unit 54 activates and executes the meeting minutes application 5502a or the browser application 5502b, which operates on the OS 5501 illustrated in FIG. 7, to access the sharing assistant server 6 or the schedule management server 8. Further, the display control unit 54 downloads, for example, WebAPP (Web Application), which includes at least HTML (Hyper Text Markup Language), and further includes CSS (Cascading Style Sheets) or JavaScript (registered trademark). The display control unit 54 further controls the display 508 to display various image data generated using the WebAPP. For example, the display control unit 54 controls the display 508 to display image data generated by HTMLS, which includes data in XML (Extensible Markup Language), JSON (JavaScript Object Notation), or SOAP (Simple Object Access Protocol).

The generation unit 56, which is implemented by the instructions of the CPU 501 illustrated in FIG. 5, generates various types of image data for display on the display 508. For example, the generation unit 56 generates various image data using content data received at the transmission/reception unit 51. In one example, the generation unit 56 renders text data as an example of content data, and generates image data for display based on the text data that has been rendered. In this example, rendering is a set of processes to interpret data described in language for web page (HTML, CSS, XML, etc.) and calculate the arrangement of characters or images to be displayed on a screen.

The audio control unit 58, which is implemented by instructions of the CPU 501 illustrated in FIG. 5, controls the speaker 515 to output an audio signal. The audio control unit 58 sets audio data to be output from the speaker 515, such that the speaker 515 outputs the audio signal based on the set audio data to reproduce audio.

The storing/reading processing unit 59, which may be implemented by the instructions of the CPU 501 and by the HDD controller 505 illustrated in FIG. 5, performs processing to store various types of data in the storage unit 5000 or read various types of data stored in the storage unit 5000. The storage unit 5000 stores an application management DB 5001, which is implemented by an application management table that is substantially the same as the application management table as illustrated in FIG. 10.

Functional Configuration of Sharing Assistant Server:

The sharing assistant server 6 includes a transmission/reception unit 61, an authentication unit 62, a creation unit 63, a generation unit 64, a determination unit 65, and a storing/reading processing unit 69. These units are functions that are implemented by or that are caused to function by operating any of the hardware elements illustrated in FIG. 5 in cooperation with the instructions of the CPU 601 according to a sharing assistant program expanded from the HD 604 to the RAM 603. The sharing assistant server 6 includes a storage unit 6000 implemented by the HD 604 illustrated in FIG. 5.

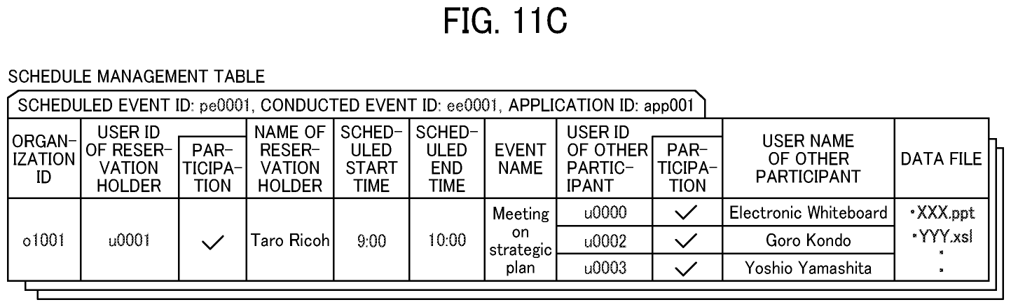

User Authentication Management Table: FIG. 11A is an illustration of an example data structure of a user authentication management table. The storage unit 6000 stores a user authentication management DB 6001, which is implemented by the user authentication management table as illustrated in FIG. 11A. The user authentication management table stores, for each user being managed, a user ID for identifying the user, a user name of the user, an organization ID for identifying an organization to which the user belongs, and a password, in association. The organization ID may be represented as a domain name assigned to an organization such as a group for managing a plurality of computers on the communication network.

Access Management Table: FIG. 11B is an illustration of an example data structure of an access management table. The storage unit 6000 stores an access management DB 6002, which is implemented by the access management table as illustrated in FIG. 11B. The access management table stores an organization ID, and an access ID and an access password required for authentication in accessing the schedule management server 8, in association. The access ID and the access password are needed for the sharing assistant server 6 to use a service (function) provided by the schedule management server 8 via such as the web API, using a protocol such as HTTP (Hypertext Transfer Protocol) or HTTPS (Hypertext Transfer Protocol Secure). Since the schedule management server 8 manages a plurality of schedulers, which may differ among the organizations, the access management table is provided to manage thee schedulers.

Schedule Management Table: FIG. 11C is an illustration of an example data structure of a schedule management table. The storage unit 6000 stores a schedule management DB 6003, which is implemented by the schedule management table as illustrated in FIG. 11C. The schedule management table stores, for each set of a scheduled event ID, a conducted event ID, and an application ID of an event, an organization ID and a user ID of a user as a reservation holder, participation of the reservation holder, a name of the reservation holder, a scheduled start time of the event, a scheduled end time of the event, a name of the event, a user ID(s) of one or more other users (other participants) in the event, participation of each other participant, names of one or more other users, and file data, in association.

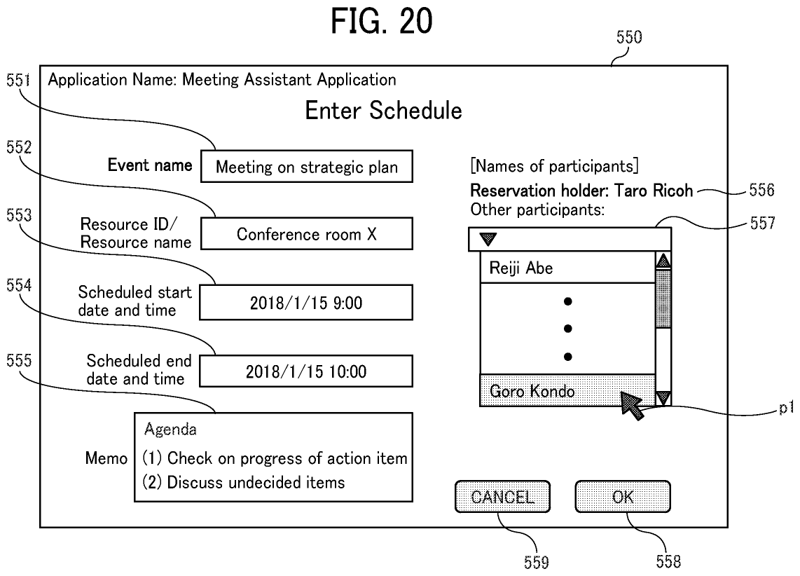

The scheduled event ID is identification information for identifying an event that has been scheduled. The scheduled event ID is an example of scheduled event identification information for identifying an event to be conducted. The conducted event ID is identification information for identifying an event that has been conducted or being conducted, from among one or more scheduled events. The conducted event ID is an example of conducted event identification information for identifying an event being conducted. The name of the reservation holder is a name of the user who has reserved to use a particular resource. For example, assuming that the resource is a conference room, a name of the user who made the reservation is a name of an organizer who has organized a meeting (an example of event) to be held in that conference room. In case where the resource is a vehicle, a name of the user who made the reservation is a name of a driver who will drive the vehicle. The scheduled start time indicates a time when the user plans to start using the reserved resource. The scheduled end time indicates a time when the user plans to end using the reserved resource. That is, with the scheduled start time and the scheduled end time, a scheduled time period for the event is defined. The event name is a name of the event to be held by the user who has reserved the resource, using the reserved resource. The user ID of other participant is identification information for identifying any participant other than the reservation holder. As a participant other than the reservation holder, any resource to be used for the event may be included. In other words, the user scheduled to attend the event, managed by the schedule management table, includes a user as a reservation holder, other user as a participant of the event, and the resource reserved by the reservation holder. The file data is data of an electronic data file, which has been registered by a user in relation to the event. For example, the user A may register the file data to be used for the event identified with the scheduled event ID, through a schedule input screen 550 described below (see FIG. 20). In this example, the file data may be generated in any desired format, using any desired application. Examples of file format of the file data include, but not limited to, a PowerPoint file and an Excel file.

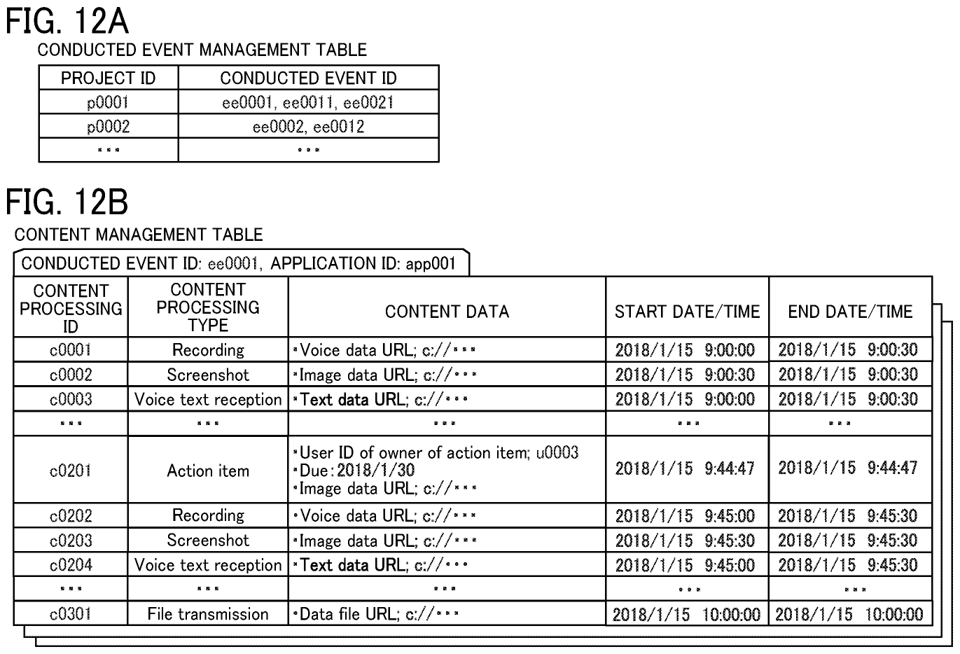

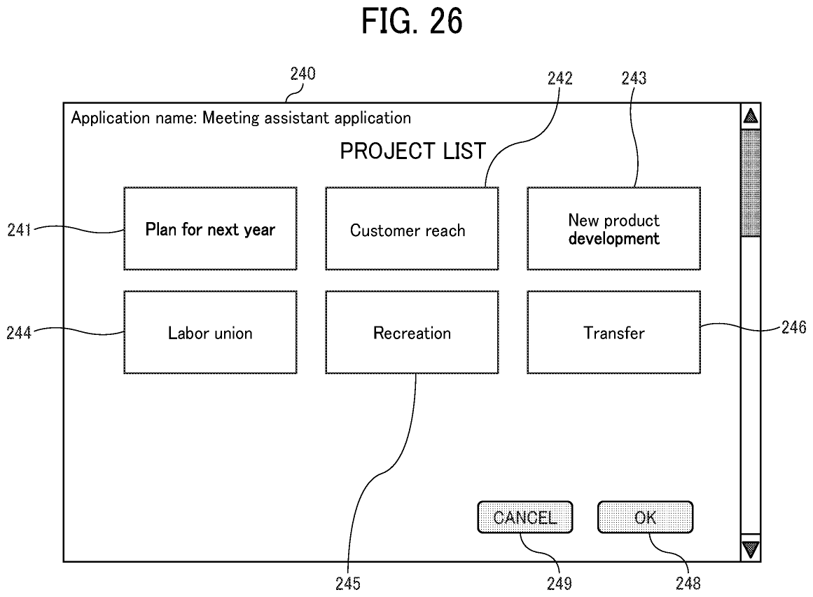

Conducted Event Management Table: FIG. 12A is an illustration of an example data structure of a conducted event management table. The storage unit 6000 stores a conducted event management DB 6004, which is implemented by the conducted event management table as illustrated in FIG. 12A. The conducted event management table stores, for each project, a project ID of the project and a conducted event ID of each of one or more events that have been performed in relation to the project, in association. The project ID is an example of identification information for identifying a project. The project is any undertaking, possibly involving research or design, that is planned to achieve a particular aim. The project is carried out by a team or a group of members, called project members. In this embodiment, the project members of a particular project can share event records such as minutes of an event for the particular project associated with the project ID. As illustrated in FIG. 26 described below, a project ID is assigned to each project, such as to the project “Plan for next year” and the project “Customer reach”. The project ID may be alternatively referred to as a group ID or a team ID, for identifying a group or team of project members. Content Management Table: FIG. 12B is an illustration of an example data structure of a content management table. The storage unit 6000 a content management DB 6005, which is implemented by the content management table as illustrated in FIG. 12B. The content management table stores, for each set of a conducted event ID and an application ID, a content processing ID, a type of content processing, content data, start date and time of content processing, and end date and time of content processing, in association. The content is any data or information that has been generated or that has been referred to, during the event held in relation to a particular project. For example, in case the event is a meeting, content being referred to may be any meeting materials such as data of presentation slides. Examples of type of content processing (“content processing type”) include audio recording (“recording”), taking screenshots (“screenshot”), reception of voice text data (“voice text reception”), generation of action item (“action item”), and transmission of a data file (“file transmission”). The content processing ID is identification information for identifying processing to be performed in relation to content generated or used during the event.

Examples of content data include information or data (“record information”) that helps to describe how the event has been progressed, and information or data that has been generated as the event is being held. In case the event is a meeting, the record information could be recorded voice data, screenshots, text data converted from voice, and meeting materials. The information or data generated during the meeting could be an action item. Screenshot is processing to capture a display screen, at any time during when the event is being held, to record as screen data. The screenshot may be alternatively referred to as capturing or image recognition.

When the content processing type is “recording”, the “content data” field includes a URL of a storage destination of voice data that has been recorded. When the content processing type is “screenshot”, the “content data” field includes a URL of a storage destination of image data generated by capturing a screen. In this disclosure, capturing is processing to store an image (still image or video image) being displayed on the display 220 of the electronic whiteboard 2 in a memory, as image data. When the content processing type is “voice text reception”, the “content data” field includes a URL of a storage destination of voice text data (text data) that has been received.

One or more action items may occur during the event, such as the meeting, in relation to a particular project. The action item indicates an action to be taken by a person related to the event or the particular project. When the content processing type is “action item”, the “content data” field includes a user ID of an owner of the action item, a due date of such action item, and a URL indicating a storage destination of image data describing the action item.

Functional Unit of Sharing Assistant Server: Next, the functional units of the sharing assistant server 6 is described in detail according to the embodiment. In the following description of the functional configuration of the sharing assistant server 6, relationships of one or more hardware elements in FIG. 5 with each functional unit of the sharing assistant server 6 in FIG. 9A will also be described.

The transmission/reception unit 61 of the sharing assistant server 6 illustrated in FIG. 9A, which is implemented by the instructions of the CPU 601 illustrated in FIG. 5 and by the network I/F 609 illustrated in FIG. 5, transmits or receives various types of data (or information) to or from another terminal, device, or system through the communication network 10.

The authentication unit 62, which is implemented by the instructions of the CPU 601 illustrated in FIG. 5, determines whether data (user ID, organization ID, and password) transmitted from the shared terminal matches any data previously registered in the user authentication management DB 6001, to perform authentication.

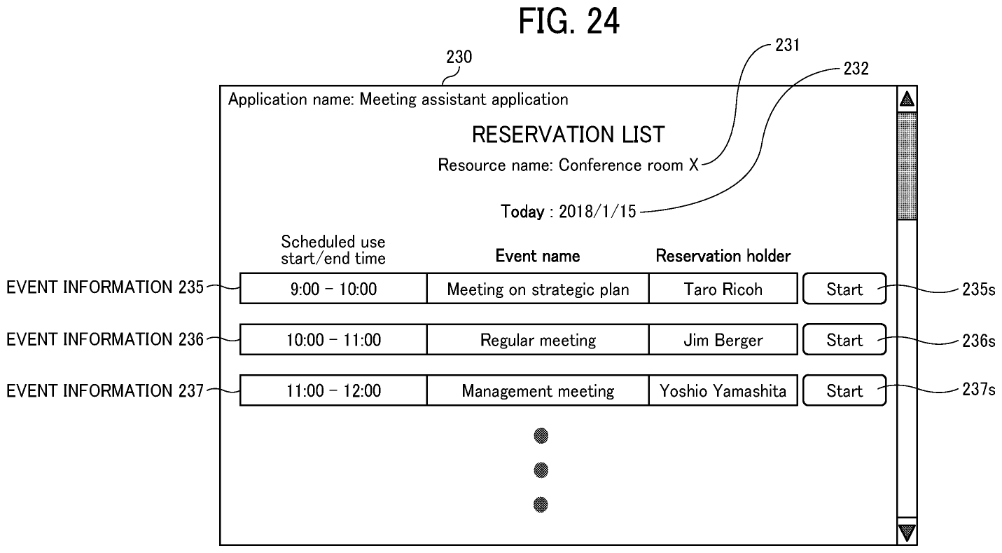

The creation unit 63, which is implemented by the instructions of the CPU 601 illustrated in FIG. 5, generates a reservation list screen 230 as illustrated in FIG. 24 described below, based on reservation information and schedule information transmitted from the schedule management server 8.

The generation unit 64, which is implemented by the instructions of the CPU 601 illustrated in FIG. 5, generates, or obtains, a conducted event ID, a content processing ID, and a URL of a storage destination of content.

The determination unit 65, which is implemented by the instructions of the CPU 601 illustrated in FIG. 5, makes various determinations to output determination results. A detailed description is given later of the determinations by the determination unit 65. The storing/reading processing unit 69, which is implemented by the instructions of the CPU 601 illustrated in FIG. 5 and by the HDD controller 605 illustrated in FIG. 5, performs processing to store various types of data in the storage unit 6000 or read various types of data stored in the storage unit 6000.

Functional Configuration of Schedule Management Server:

The schedule management server 8 includes a transmission/reception unit 81, an authentication unit 82, a generation unit 83, and a storing/reading processing unit 89. These units are functions that are implemented by or that are caused to function by operating any of the elements illustrated in FIG. 5 in cooperation with the instructions of the CPU 801 according to the schedule management program expanded from the HD 804 to the RAM 803. The schedule management server 8 includes a storage unit 8000 implemented by the HD 804 illustrated in FIG. 5.

User Authentication Management Table:

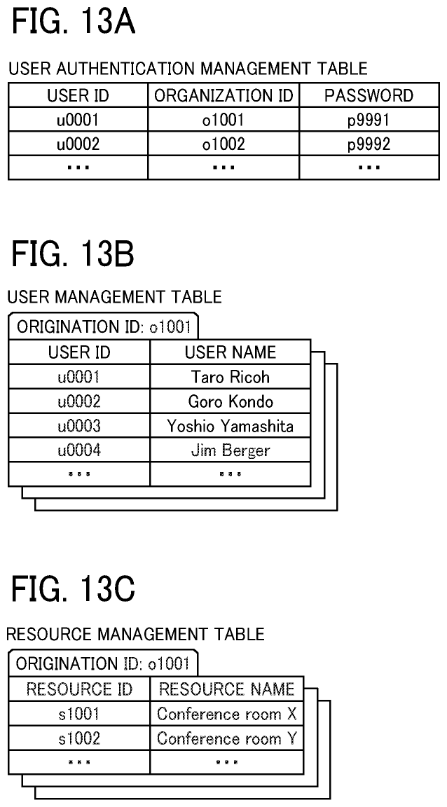

FIG. 13A is an illustration of an example data structure of a user authentication management table. The storage unit 8000 stores a user authentication management DB 8001, which is implemented by the user authentication management table as illustrated in FIG. 13A. The user authentication management table of FIG. 13A stores, for each user being managed, a user ID for identifying the user, an organization ID for identifying an organization to which the user belongs, and a password, in association.

User Management Table: FIG. 13B is an illustration of an example data structure of a user management table. The storage unit 8000 stores a user management DB 8002, which is implemented by the user management table as illustrated in FIG. 13B. The user management table stores, for each organization ID, one or more user IDs each identifying the user belonging to that organization, and names of the one or more users, in association.

Resource Management Table: FIG. 13C is an illustration of an example data structure of a resource management table. The storage unit 8000 stores a resource management DB 8003, which is implemented by the resource management table as illustrated in FIG. 13C. The resource management table stores, for each organization ID, one or more resource IDs each identifying the resource managed by that organization, and names of the one or more resources, in association.

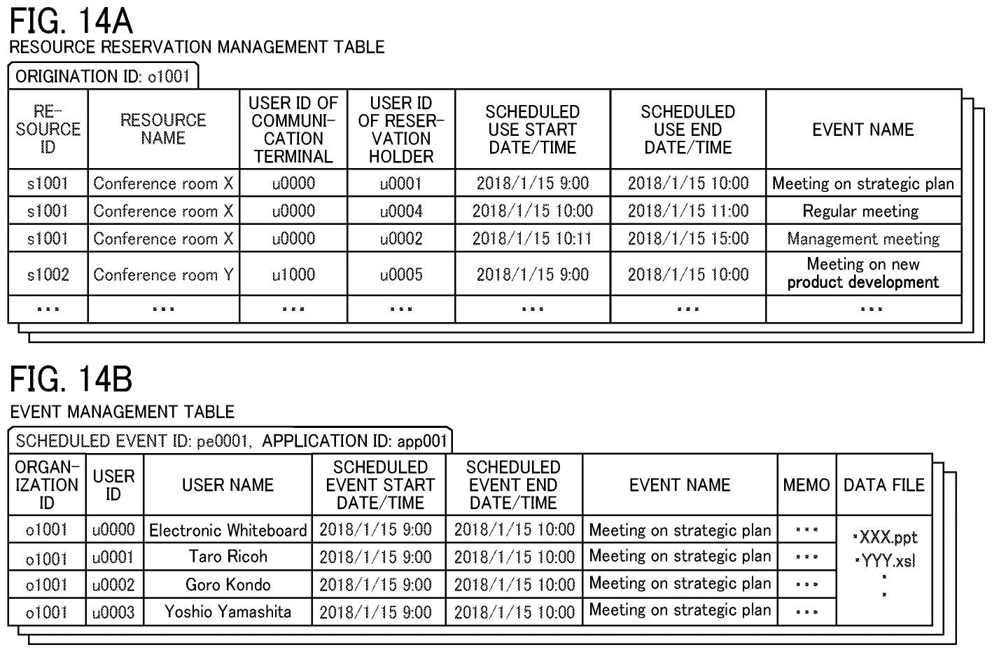

Resource Reservation Management Table: FIG. 14A is an illustration of an example data structure of a resource reservation management table. The storage unit 8000 stores a resource reservation management DB 8004, which is implemented by the resource reservation management table illustrated in FIG. 14A. The resource reservation management table manages, for each organization, reservation information in which various data items relating to a reserved resource are associated. The reservation information includes, for each organization ID, a resource ID and a resource name of a reserved resource, a user ID of a communication terminal, a user ID of a reservation holder who made reservation, a scheduled start date and time and a scheduled end date and time of an event in which the reserved resource is to be used, and an event name of such event. The scheduled start date and time indicates a date and time when the user plans to start using the reserved resource. The scheduled end date and time indicates a date and time when the user plans to end using the reserved resource. In this example, while the date and time is expressed in terms of year, month, date, hour, minute, second, and time zone, FIG. 14A only illustrates year, month, date, hour, and minute for simplicity.

Event Management Table: FIG. 14B is an illustration of an example data structure of an event management table. The storage unit 8000 stores an event management DB 8005, which is implemented by the event management table as illustrated in FIG. 14B. The event management table manages, for each event, event schedule information in which various data items relating to an event are associated. Specifically, the event management table stores, for each set of a scheduled event ID and an application ID, an organization ID, a user ID, and a user name, a scheduled start date and time of the event, a scheduled end date and time of the event, and a name of the event, in association. The scheduled start date and time of the event indicates a date and time of the event that the user plans to participate starts. The scheduled end date and time of the event indicates a date and time of the event that the user plans to participate ends. In this example, while the date and time is expressed in terms of year, month, date, hour, minute, second, and time zone, FIG. 14A only illustrates year, month, date, hour, and minute for simplicity. The event management table further stores, for each set of a scheduled event ID and an application ID, a memo, and file data such as data of meeting materials used in the event indicated by the event schedule information.

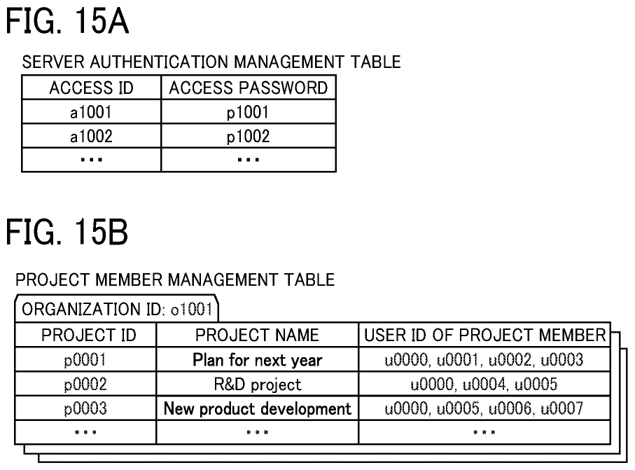

Server Authentication Management Table: FIG. 15A is an illustration of an example data structure of a server authentication management table. The storage unit 8000 stores a server authentication management DB 8006, which is implemented by the server authentication management table as illustrated in FIG. 15A. The server authentication management table stores an access ID and an access password in association. In authentication, the schedule management server 8 determines whether the access ID and the access password transmitted from the sharing assistant server 6 matches the access ID and the access password stored in the server authentication management DB 8006. That is, data managed by the sharing assistant server 6 using the access management table of FIG. 11B, and data managed by the schedule management server 8 using the server authentication management table of FIG. 15A are to be kept the same.

Project Member Management Table: FIG. 15B is an illustration of an example data structure of a project member management table. The storage unit 8000 stores a project member management DB 8007, which is implemented by the project member management table as illustrated in FIG. 15B. The project member management table stores, for each project being managed by each organization having the organization ID, a project ID, a project name, and a user ID of each project member, in association.

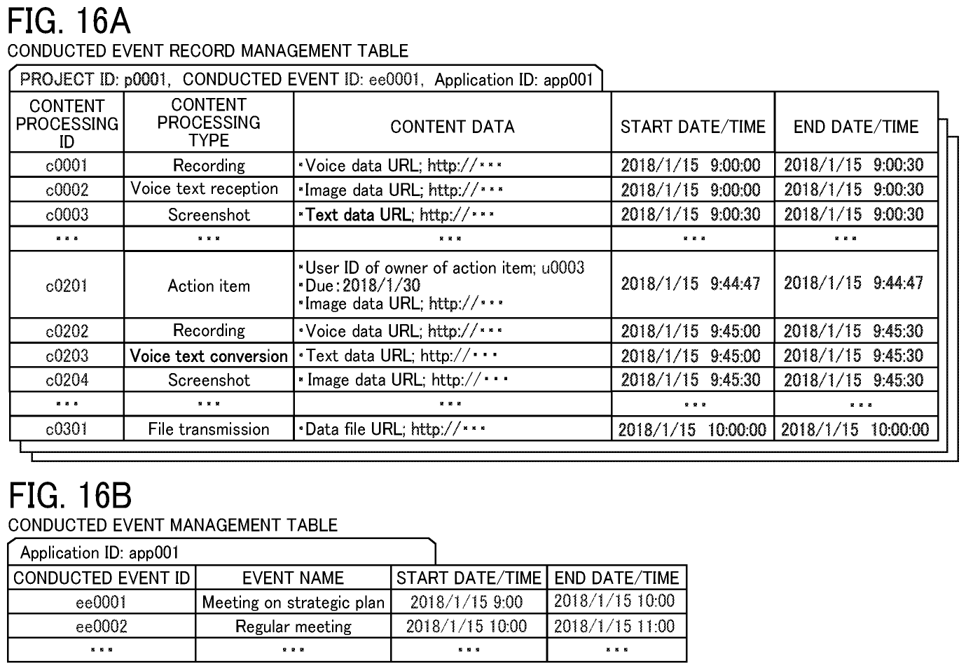

Conducted Event Record Management Table: FIG. 16A is an illustration of an example data structure of a conducted event record management table. The storage unit 8000 stores a conducted event record management DB 8008, which is implemented by the conducted event record management table as illustrated in FIG. 16A. The conducted event record management table stores, for each set of project ID, conducted event ID, and application ID, a content processing ID, a type of content processing, content data, a start date and time of content processing, and an end date and time of content processing, in association. A part of data stored in the conducted event record management DB 8008 is the same as the data stored in the content management DB 6005. That is, the conducted event ID, application ID, content processing ID, type of content processing, start date and time of content processing, and end date and time of content processing, are the same between the content management DB 6005 and the conducted event record management DB 8008. The data in the “content data” field, that is, the storage destination of content, is managed using a different expression format, while the actual storage location is the same. Specifically, the storage destination is described in c:// (local drive) for the content management table (FIG. 12B), and in http:// for the conducted event record management table (FIG. 16A).

Conducted Event Management Table: FIG. 16B is an illustration of an example data structure of a conducted event management table. The storage unit 8000 stores a conducted event management DB 8009, which is implemented by the conducted event management table illustrated as in FIG. 16B. The conducted event management table stores, for each application ID, a conducted event ID, an event name, an event start date and time, and an event end date and time, in association. From among the schedule information stored in the event management DB 8005, information related to one or more events that have been actually held (called “conducted event”) are managed using the conducted event management DB 8009.

Functional Unit of Schedule Management Server: Next, each functional unit of the schedule management server 8 is described in detail according to the embodiment. In the following description of the functional configuration of the schedule management server 8, relationships of one or more hardware elements in FIG. 5 with each functional unit of the schedule management server 8 in FIG. 9B will also be described.

The transmission/reception unit 81 of the schedule management server 8 illustrated in FIG. 9B, which is implemented by the instructions of the CPU 801 illustrated in FIG. 5 and by the network I/F 809 illustrated in FIG. 5, transmits or receives various types of data (or information) to or from another terminal, device, or system through the communication network 10. The transmission/reception unit 81 is an example of second transmitting means. Further, the transmission/reception unit 81 is an example of second receiving means.

The authentication unit 82, which is implemented by the instructions of the CPU 801 illustrated in FIG. 5, determines whether data (user ID, organization ID, and password) transmitted from the resource matches any data previously registered in the user authentication management DB 8001. The authentication unit 82 determines whether data (access ID and access password) transmitted from the sharing assistant server 6 matches any data previously registered in the server authentication management DB 8006, to authenticate the sharing assistant server 6.

The generation unit 83, which is implemented by the instructions of the CPU 801 illustrated in FIG. 5, generates various types of information.

The storing/reading processing unit 89, which is implemented by the instructions of the CPU 801 illustrated in FIG. 5 and by the HDD controller 805 illustrated in FIG. 5, performs processing to store various types of data in the storage unit 8000 or read various types of data stored in the storage unit 8000. The storage unit 8000 is an example of storing means.

Functional Configuration of Voice-to-Text Conversion Server:

The voice-to-text conversion server 9 includes a transmission/reception unit 91, a conversion unit 93, and a storing/reading processing unit 99. These units are functions that are implemented by or that are caused to function by operating any of the elements illustrated in FIG. 5 in cooperation with the instructions of the CPU 901 according to the control program expanded from the HD 904 to the RAM 903. The voice-to-text conversion server 9 includes a storage unit 9000, implemented by the HD 904 illustrated in FIG. 5.

Functional Unit of Voice-to-Text Conversion Server: Next, each functional unit of the voice-to-text conversion server 9 is described in detail according to the embodiment. In the following description of the functional configuration of the voice-to-text conversion server 9, relationships of one or more hardware elements in FIG. 5 with each functional unit of the voice-to-text conversion server 9 in FIG. 9B will also be described.

The transmission/reception unit 91 of the voice-to-text conversion server 9 illustrated in FIG. 9B, which is implemented by the instructions of the CPU 901 illustrated in FIG. 5 and by the network I/F 909 illustrated in FIG. 5, transmits or receives various types of data (or information) to or from another terminal, device, or system through the communication network 10.

The conversion unit 93, which is implemented by the instructions of the CPU 901 illustrated in FIG. 5, converts voice data received at the transmission/reception unit 91 via the communication network 10, into text data (voice text data).

The storing/reading processing unit 99, which is implemented by the instructions of the CPU 901 illustrated in FIG. 5 and by the HDD controller 905 illustrated in FIG. 5, performs processing to store various types of data in the storage unit 9000 or read various types of data stored in the storage unit 9000.

In this disclosure, any one of the IDs described above is an example of identification information identifying the device or terminal, or the user operating the device or terminal. Examples of the organization ID include, but not limited to, a name of a company, a name of a branch, a name of a business unit, a name of a department, and a name of a region. In alternative to the user ID identifying a specific user, an employee number, a driver license number, and an individual number called “My Number” under the Japan's Social Security and Tax Number System, may be used as identification information for identifying the user.

Operation:

The following describes one or more operations to be performed by the sharing system 1.

Processing to Register Schedule:

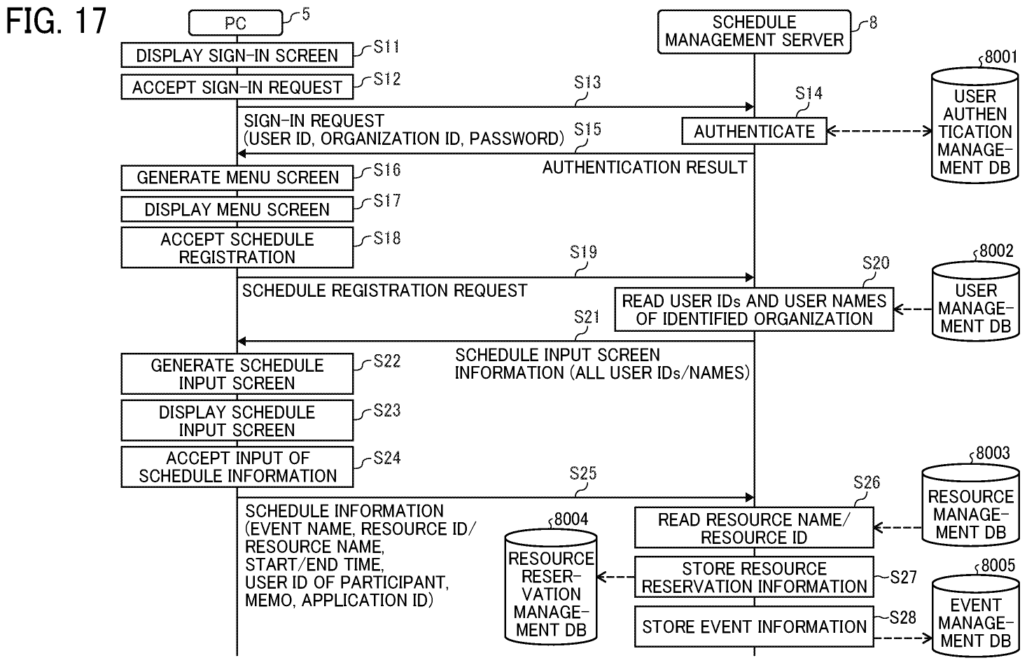

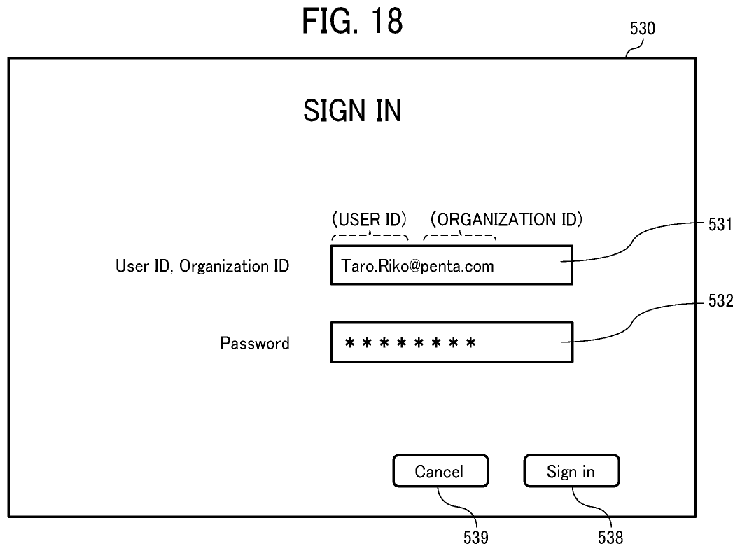

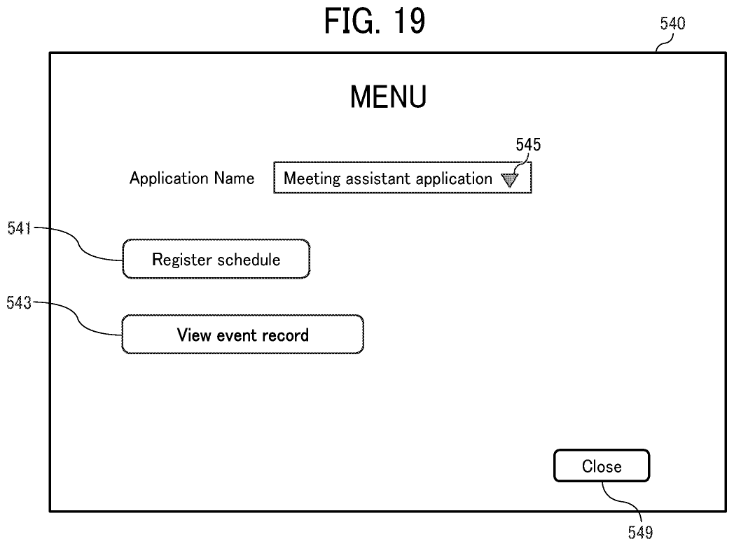

Referring to FIG. 17 to FIG. 20, processing of registering a schedule of a user A (Taro Ricoh) to the schedule management server 8, using the PC 5, is described according to an example. FIG. 17 is a sequence diagram illustrating operation of registering schedule, according to an embodiment. FIG. 18 is an illustration of an example of a sign-in screen. FIG. 19 is an illustration of an example of a menu screen displayed by the PC 5. FIG. 20 is an illustration of an example of a schedule input screen.

In response to an operation to the keyboard 511, for example, of the PC 5 by the user A, the display control unit 54 of the PC 5 displays a sign-in screen 530 on the display 508 as illustrated in FIG. 18 (S11). The sign-in screen 530 allows the user to sign (log) into the schedule management server 8. The sign-in screen 530 includes an entry field 531 for entering a user ID and an organization ID of a user, an entry field 532 for entering a password, a sign-in button 538 to be pressed when executing sign-in processing, and a cancel button 539 to be pressed when canceling the sign-in processing. In this case, the user ID and the organization ID are each extracted from an e-mail address of the user A. Specifically, a user name of the email address represents the user ID, and a domain name of the email address represents the organization ID. While only one entry field 531 for entering the email address is illustrated in FIG. 18, an entry field may be provided for each of the user ID and the organization ID.

Through the sign-in screen 530, the user enters the user ID and the organization ID of his/her own into the entry field 531, enters the password of his/her own into the entry field 532, and presses the sign-in button 538. In response to such user operation, the acceptance unit 52 of the PC 5 accepts a request for sign-in processing (S12). The transmission/reception unit 51 of the PC 5 transmits sign-in request information indicating a request for sign-in to the schedule management server 8 (S13). The sign-in request information includes the user ID, organization ID, and password, which are accepted at S12. Accordingly, the transmission/reception unit 81 of the schedule management server 8 receives the sign-in request information.

Next, the authentication unit 82 of the schedule management server 8 authenticates the user A using the user ID, the organization ID, and the password (S14). Specifically, the storing/reading processing unit 89 determines whether a set of the user ID, the organization ID, and the password, which is obtained from the sign-in request information received at S13, has been registered in the user authentication management DB 8001 (FIG. 13A). When there is the set of the user ID, the organization ID, and the password in the user authentication management DB 8001, the authentication unit 82 determines that the user A who has sent the sign-in request is an authorized user. When there is no such set of the user ID, the organization ID, and the password in the user authentication management DB 8001, the authentication unit 82 determines that the user A is an unauthorized (illegitimate) user. When the authentication unit 82 determines that the user A is an illegitimate user, the transmission/reception unit 81 sends to the PC 5 a notification indicating that the user A is the illegitimate user. In the following, it is assumed that the user A is determined to be an authorized user.

The transmission/reception unit 81 transmits an authentication result to the PC 5 (S15). The transmission/reception unit 51 of the PC 5 receives the authentication result.

When the authentication result is received at S15, the generation unit 56 of the PC 5 generates data of a menu screen 540 for display as illustrated in FIG. 19 (S16). The display control unit 54 of the PC 5 controls the display 508 to display the menu screen 540 as illustrated in FIG. 19 (S17). In this example, the menu screen 540 includes a “Register Schedule” button 541 for registering a schedule, a “View event record” button 543 for viewing a conducted event record, and a pull-down menu 545 for selecting a desired external application 103. When the user selects a desired external application 103 through the pull-down menu 545 and then presses the “Register Schedule” button 541, the acceptance unit 52 accepts a request for schedule registration (S18). In this case, the storing/reading processing unit 59 searches the application management DB 5001 (FIG. 10), using the application name of the external application 103 for which selection is accepted by acceptance unit 52 in response to the user's operation on the pull-down menu 545 as a search key, to read the application ID associated with the application name. The transmission/reception unit 51 of the PC 5 transmits the schedule registration request to the schedule management server 8 (S19). This schedule registration request includes an application ID for identifying the external application 103 selected through the pull-down menu 545. Accordingly, the transmission/reception unit 81 of the schedule management server 8 receives the schedule registration request.

Next, the storing/reading processing unit 89 of the schedule management server 8 searches the user management DB 8002 (FIG. 13B), using the organization ID received at S13 as a search key, to read out all user IDs and all user names that are associated with the received organization ID (S20). The transmission/reception unit 81 transmits schedule input screen information to the PC 5 (S21). The schedule input screen information includes all user IDs and all user names read out at S20. Here, all user names include the name of the user A who has entered various information at S12 to request for sign-in processing to input schedule information. The transmission/reception unit 51 of the PC 5 receives the schedule input screen information.

The generation unit 56 of the PC 5 generates data of a schedule input screen 550 for display, based on the schedule input screen information received at S21 (S22). The display control unit 54 of the PC 5 controls the display 508 to display the schedule input screen 550 as illustrated in FIG. 20 (S23).

The schedule input screen 550 includes the application name of the external application 103 selected at S18, an entry field 551 for an event name, an entry field 552 for a resource ID or a resource name, and an entry field 553 for a scheduled start date and time of the event (use of the resource), an entry field 554 for a scheduled end date and time of the event (use of the resource), an entry field 555 for entering memo such as agenda, a display field 556 for displaying a name of a reservation holder (in this example, the user A) who is making a reservation, a selection menu 557 for selecting one or more participants other than the reservation holder by name, an “OK” button 558 to be pressed when requesting for registration of reservation, and a “CANCEL” button 559 to be pressed when cancelling any content being entered or has been entered. The name of the reservation holder is a name of the user who has entered various information using the PC 5 to request for sing-in processing at S12. FIG. 20 further illustrates a mouse pointer p1.

The user may enter an email address of the resource in the entry field 552, as an identifier of the resource to be reserved. Further, the selection menu 557 may allow the reservation holder to select one or more resources by name. When a name of a particular resource is selected from the selection menu 557, that selected resource is added as one of participants in the event.

The user A enters items as described above in the entry fields 551 to 555, selects the name of each user participating in the event from the selection menu 557 by moving the pointer p1 with the mouse, and presses the “OK” button 558. In response to pressing of the “OK” button 558, the acceptance unit 52 of the PC 5 accepts input of schedule information (S24). The transmission/reception unit 51 transmits the schedule information, which has been accepted, to the schedule management server 8 (S25). The schedule information includes an event name, a resource ID (or a resource name), a scheduled start date and time, a scheduled end date and time, a user ID of each participant, information on memo, and an application ID. When a resource ID is entered in the entry field 552 on the schedule input screen 550, the PC 5 transmits the entered resource ID as part of schedule information. When a resource name is entered in the entry field 552, the PC 5 transmits the entered resource name as part of schedule information. Here, only the user name is selected from the selection menu 557 on the schedule input screen 550. However, since the PC 5 has received the user IDs at S21, the PC 5 transmits the user ID corresponding to each of the user names that have been selected as part of schedule information. Accordingly, the transmission/reception unit 81 of the schedule management server 8 receives the schedule information.

Next, the storing/reading processing unit 89 of the schedule management server 8 searches the resource management DB 8003 (FIG. 13C) using the resource ID (or resource name) received at S25 as a search key, to obtain the corresponding resource name (or resource ID) (S26).

The storing/reading processing unit 89 stores the reservation information in the resource reservation management DB 8004 (FIG. 14A) (S27). In this case, the storing/reading processing unit 89 adds one record of reservation information to the resource reservation management table in the resource reservation management DB 8004 managed by a scheduler previously registered (that is, the scheduler managed for a particular organization). The reservation information is generated based on the schedule information received at S25 and the resource name (or resource ID) read out at S26. The scheduled start date and time in the resource reservation management DB 8004 corresponds to the scheduled start date and time in the schedule information. The scheduled end date and time in the resource reservation management DB 8004 corresponds to the scheduled end date and time in the schedule information.

The storing/reading processing unit 89 stores the schedule information in the event management DB 8005 (FIG. 14B) (S28). In this case, the storing/reading processing unit 89 adds one record of schedule information (that is, event schedule information) to the event management table in the event management DB 8005 managed by the scheduler that is previously registered (that is, the scheduler managed for a particular organization). The schedule information is generated based on the schedule information received at S25. The event start schedule date and time in the event management DB 8005 corresponds to the scheduled start date and time in the schedule information. The event end schedule date and time in the event management DB 8005 corresponds to the scheduled end date and time in the schedule information.

As described above, the user A registers his or her schedule to the schedule management server 8.

Processing to Start Event:

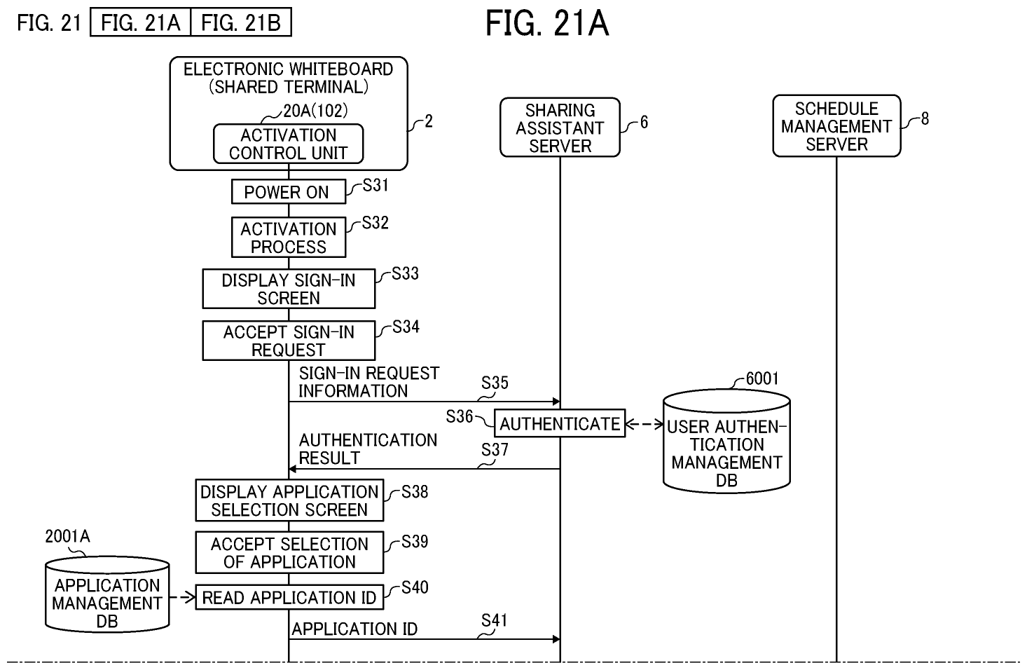

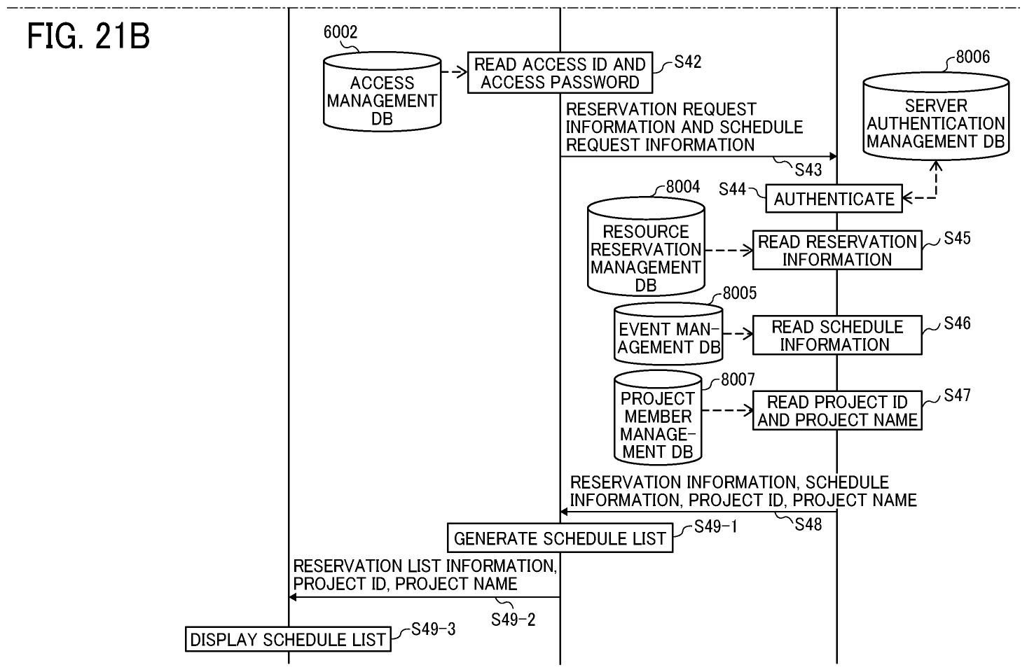

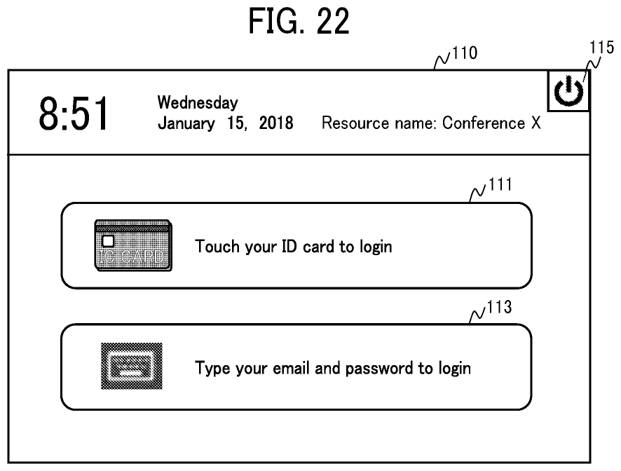

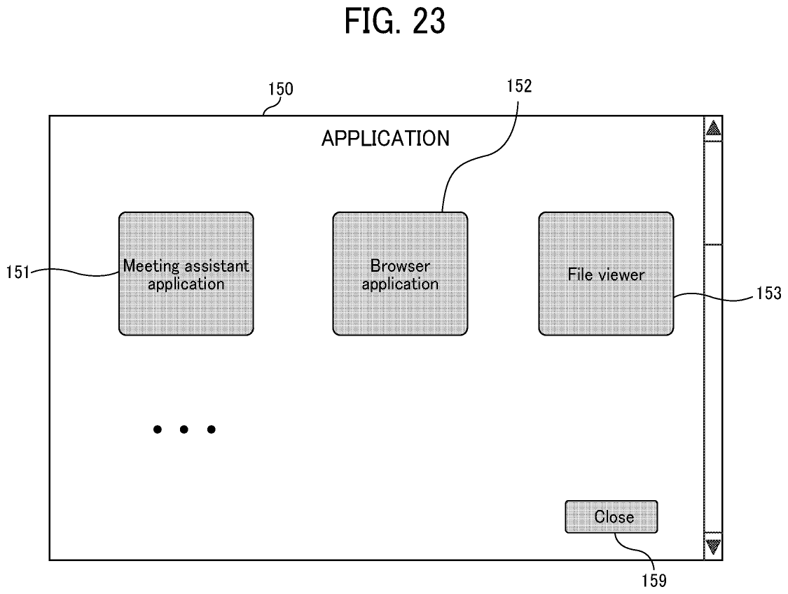

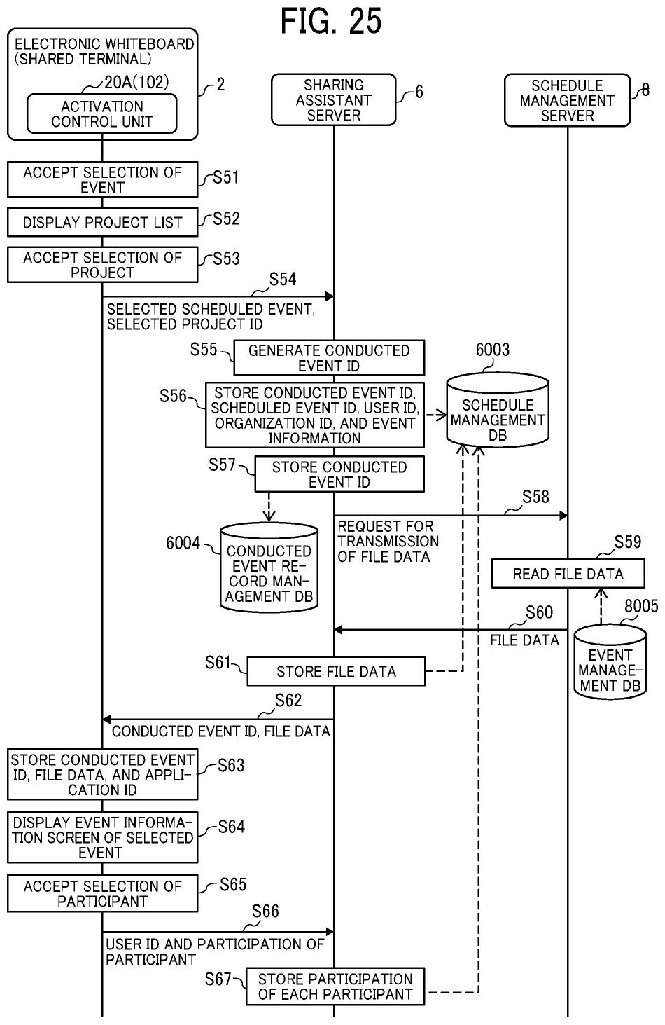

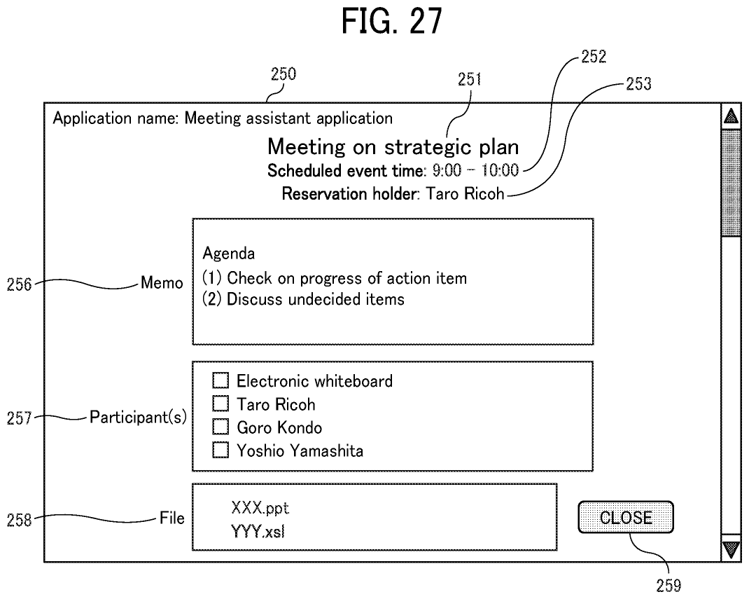

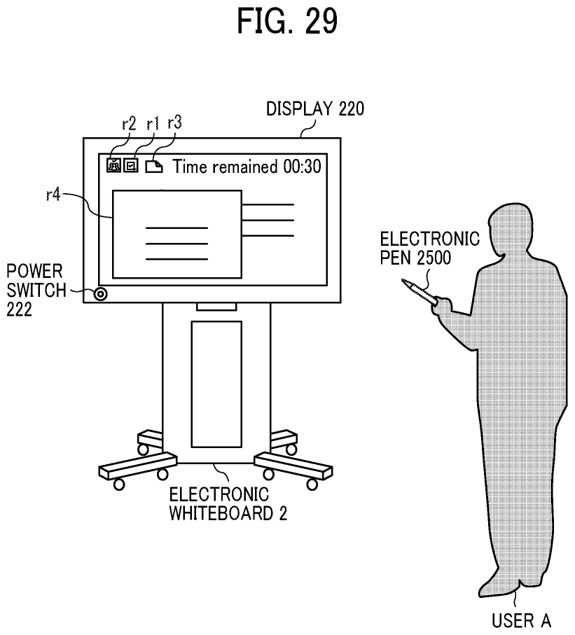

Referring to FIG. 21A to FIG. 29, operation of conducting a meeting with meeting participants using the electronic whiteboard 2, in the conference room X that has been reserved by the user A (Taroh Ricoh), is described according to an embodiment. FIG. 21A, FIG. 21B and FIG. 25 are a sequence diagram illustrating a processing to start an event, such as a meeting, according to the embodiment. FIG. 22 is an illustration of an example of a sign-in screen, displayed by the electronic whiteboard 2. FIG. 23 is an illustration of an example of an application selection screen. FIG. 24 is an illustration of an example of a resource reservation list screen. FIG. 26 is an illustration of an example of a project list screen. FIG. 27 is an illustration of an example of an event information screen. FIG. 29 is an illustration for explaining a use scenario of the electronic whiteboard 2 by a user, according to the embodiment. In the following description, it is assumed that the Launcher 102 is, for example, an application having a function of displaying an event schedule of a meeting or the like, and the external application 103 is, for example, a meeting assistant application 103a that supports conduct of an event such as a meeting.

As the power switch 222 of the electronic whiteboard 2 is turned on by the user, the acceptance unit 22A of the activation control unit 20A accepts a turn-on operation by the user (S31). The activation processing unit 25A of the activation control unit 20A activates the Launcher 102 illustrated in FIG. 6, in response to acceptance of the turn-on operation by the acceptance unit 22A (S32). The display control unit 24A of the activation control unit 20A displays a sign-in screen 110 on the display 220 as illustrated in FIG. 22 (S33). The sign-in screen 110 allows a user to sign in the sharing assistant server 6. The sign-in screen 110 includes a selection icon 111, a selection icon 113, and a power-on icon 115. In this example, the selection icon 111 is pressed by the user A to request for sign-in using the IC card of the user A. The selection icon 113 is pressed by the user A to request for sign-in using an email address and a password of the user A. The power-on icon 115 is pressed to turn off the electronic whiteboard 2, without performing sign-in operation.

In response to pressing of the selection icon 111 or the selection icon 113, the acceptance unit 22A of the activation control unit 20A accepts a request for sign-in (S34). In one example, the user A presses the selection icon 111, and brings his or her IC card into close contact with the short-range communication circuit 219 (such as an IC card reader). In another example, the user A presses the selection icon 113, and enters the email address and password of the user A. The transmission/reception unit 21A of the activation control unit 20A transmits sign-in request information indicating a sign-in request to the sharing assistant server 6 (S35). The sign-in request information includes information on a time zone of a country or a region where the electronic whiteboard 2 is located, and the user ID, organization ID, and password of the user using the electronic whiteboard 2, which is one example of the shared terminal. Accordingly, the transmission/reception unit 61 of the sharing assistant server 6 receives the sign-in request information.

Next, the authentication unit 62 of the sharing assistant server 6 authenticates the user A using the user ID, the organization ID, and the password (S36). Specifically, the storing/reading processing unit 69 determines whether a set of the user ID, the organization ID, and the password, which is obtained from the sign-in request information at S36, has been registered in the user authentication management DB 6001 (FIG. 11A). When there is the set of the user ID, the organization ID, and the password in the user authentication management DB 6001, the authentication unit 62 determines that the user A who has sent the sign-in request is an authorized (legitimate) user. When there is no such set of the user ID, the organization ID, and the password in the user authentication management DB 6001, the authentication unit 62 determines that the user A is an unauthorized (illegitimate) user. When the authentication unit 62 determines that the user A is illegitimate, the transmission/reception unit 61 sends to the electronic whiteboard 2 a notification indicating the illegitimate user. In the following, it is assumed that the user A is determined to be an authorized user.

The transmission/reception unit 61 transmits an authentication result to the electronic whiteboard 2 (S37). Accordingly, the transmission/reception unit 21A of the activation control unit 20A of the electronic whiteboard 2 receives the authentication result.

The display control unit 24A of the activation control unit 20A controls the display 220 to display application selection screen 150 as illustrated in FIG. 23 (S38). The application selection screen 150 is a display screen that allows a user to select the external application 103 to be activated. The application selection screen 150 includes application images 151 to 153 for identifying the external applications 103 installed on the electronic whiteboard 2. Each of the application images 151 to 153 include an application name for identifying the corresponding external application 103. The application selection screen 150 further includes a “Close” button 159 to be pressed when closing the application selection screen 150.

When the user A presses any one of the application images 151 to 153 included in the application selection screen 150, the acceptance unit 22A of the activation control unit 20A accepts selection of the external application 103 identified by the application image pressed by the user (S39). The storing/reading processing unit 29A of the activation control unit 20A searches the application management DB 2001 (FIG. 10) using the application name corresponding to the application image for which selection is accepted by the acceptance unit 22A as a search key, to obtain the application ID associated with the application name (S40). Next, the transmission/reception unit 21A of the activation control unit 20A transmits the application ID obtained by the storing/reading processing unit 29A to the sharing assistant server 6 (S41). Accordingly, the transmission/reception unit 61 of the sharing assistant server 6 receives the application ID.

Next, the storing/reading processing unit 69 of the sharing assistant server 6 searches the access management DB 6002 (FIG. 11B) using the organization ID received at S35 as a search key to obtain the access ID and access password that correspond to the received organization ID (S42).

The transmission/reception unit 61 of the sharing assistant server 6 transmits, to the schedule management server 8, reservation request information indicating a request for reservation information of a resource, and schedule request information indicating a request for schedule information of a user (S43). The reservation request information and the schedule request information each include the time zone information, and the user ID and organization ID of a user of the shared terminal (the electronic whiteboard 2 in this case) received at S35. The reservation request information and the schedule request information each further includes the application ID received at S41. The reservation request information and the schedule request information each further includes the access ID and the password obtained at S42. Accordingly, the transmission/reception unit 81 of the schedule management server 8 receives the reservation request information and the schedule request information.

Next, the authentication unit 82 of the schedule management server 8 authenticates the sharing assistant server 6 using the access ID and the access password (S44). Specifically, the storing/reading processing unit 89 searches the server authentication management DB 8006 (FIG. 15A) using a set of the access ID and the password received at S43 as a search key, to determine whether the same set of the access ID and the password have been registered. When there is the set of the access ID and the password in the server authentication management DB 8006, the authentication unit 82 determines that the sharing assistant server 6 that has sent the request is an authorized entity. When there is no such set of the access ID and the password in the server authentication management DB 8006, the authentication unit 82 determines that the sharing assistant server 6 that has sent the request is an unauthorized (illegitimate) entity. When the authentication unit 82 determines that the sharing assistant server 6 is illegitimate, the transmission/reception unit 81 sends to the sharing assistant server 6, a notification indicating the illegitimate entity. In the following, it is assumed that the sharing assistant server 6 is determined to be an authorized entity.

The storing/reading processing unit 89 of the schedule management server 8 searches the shared resource reservation management DB 8004 (FIG. 14A), which is managed by the scheduler specified in the above, using the user ID of a user of the shared terminal (in this example, the electronic whiteboard 2) received at S43 as a search key, to read reservation information having the user ID in its record (S45). In this case, the storing/reading processing unit 89 reads the reservation information whose scheduled start date is today.

Further, the storing/reading processing unit 89 of the schedule management server 8 searches the event management DB 8005 (FIG. 14B) specified in the above, using the user ID of the user of the shared terminal (in this example, the electronic whiteboard 2) received at S43 and the application ID received at S43 as a search key, to read schedule information associated with the user ID and the application ID (S46). In this case, the storing/reading processing unit 89 reads the schedule information whose scheduled start date and time or the event is today. When the schedule management server 8 is located in a country or region having a time zone that differs from a time zone applied to the shared terminal such as the electronic whiteboard 2, the electronic whiteboard 2 adjusts the time zone according to a local time zone applicable to a place where the shared terminal is provided.

Next, the storing/reading processing unit 89 searches the project member management DB 8007 (FIG. 15B) using the user ID of the user of the shared terminal such as the electronic whiteboard 2 received at S43, to obtain project IDs and project names of all projects having the user ID of the user of the shared terminal in its record (S47).

The transmission/reception unit 81 transmits, to the sharing assistant server 6, the reservation information obtained at S45, the schedule information obtained at S46, and project IDs and project names of all projects that are obtained at S47 (S48). Accordingly, the transmission/reception unit 61 of the sharing assistant server 6 receives the reservation information, the schedule information, and the project IDs and project names.

Next, the creation unit 63 of the sharing assistant server 6 generates a reservation list based on the reservation information and the schedule information received at S48 (S49-1). The transmission/reception unit 61 transmits reservation list information indicating the contents of the reservation list, and the project IDs and project names of all projects, to the electronic whiteboard 2 (S49-2). Accordingly, the transmission/reception unit 21A of the activation control unit 20A of the electronic whiteboard 2 receives the reservation list information, and the project IDs and project names.

Next, the display control unit 24A of the activation control unit 20A of the electronic whiteboard 2 controls the display 220 to display a reservation list screen 230 as illustrated in FIG. 24 (S49-3). The reservation list screen 230 includes the application name of the external application 103 selected at S39, a display area 231 for displaying a resource name (in this case, a name of location such as a conference room) and a display area 232 for displaying the current (today's) date and time. The reservation list screen 230 further includes event information 235, 236, 237, etc. each indicating an event in which the target resource (here, in this case, the conference room X) is used. Each item of event information includes a scheduled start time and a scheduled end time for using the target resource, an event name, and a name of a user who has reserved the target resource. Along with the event information 235, 236, and 237, corresponding start buttons 235s, 236s, and 237s are displayed, each of which is pressed by the user when an event is started. The reservation list screen 230 is an example of an event selection screen.

Referring to FIG. 25, when the user A presses the start button 235s with the electronic pen 2500 or the like, the acceptance unit 22A of the activation control unit 20A accepts a selection of the event indicated by the event information 235 (S51). Further, the display control unit 24A of the activation control unit 20A controls the display 220 to display a project list screen 240 as illustrated in FIG. 26, based on the project IDs and project names that are received at S49-2 (S52). The project list screen 240 includes the application name of the external application 103 selected at step S39, and project icons 241 to 246 each representing a particular project indicated by the project ID or project name that is received. The project list screen 240 further includes an “OK” button 248 to be pressed to confirm the selected project icon, and a “CANCEL” button 249 to be pressed to cancel selection of the project icon.

For example, referring to FIG. 26, when the user A presses the project icon 241 with the electronic pen 2500 or the like, the acceptance unit 22A of the activation control unit 20A accepts a selection of the project indicated by the project icon 241 (S53).

The transmission/reception unit 21A of the activation control unit 20A of the electronic whiteboard 2 transmits, to the sharing assistant server 6, a scheduled event ID identifying the scheduled event selected at S51, and a project ID identifying the project selected at S53 (S54). Processing of S54 may be referred to as processing to transmit a request for conducted event identification information. Accordingly, the transmission/reception unit 61 of the sharing assistant server 6 receives the scheduled event ID of the selected event, and the project ID of the selected project.

Next, the generation unit 64 of the sharing assistant server 6 generates a conducted event ID, which can uniquely identify the conducted event (S55). Next, the storing/reading processing unit 69 of the sharing assistant server 6 stores, in the schedule management DB 6003 (FIG. 11C), the conducted event ID generated at S55, the scheduled event ID received at S54, the user ID and organization ID of the reservation holder, the other data items related to the event, and the application ID in association (S56). The user ID and organization ID of the reservation holder, and the other data items related to the event, are obtained from the reservation information and/or the schedule information received at S48. The application ID is the ID received at S41. At this point, there is no entry in the “participation” field in the schedule management table (FIG. 11C).

Next, the storing/reading processing unit 69 of the sharing assistant server 6 stores, in the conducted event management DB 6004 (FIG. 12A), the project ID received at S54, and the conducted event ID generated at S55, in association (S57).

The transmission/reception unit 61 of the sharing assistant server 6 transmits, to the schedule management server 8, a file data transmission request information indicating a request for transmitting file data that has been registered in the schedule management server 8 (S58). The file data transmission request information includes the scheduled event ID received at S54, the user ID and organization ID of the user of the shared terminal (in this example, the electronic whiteboard 2) received at S35, the access ID and access password read at S42, and the application ID received at S41. Accordingly, the transmission/reception unit 81 of the schedule management server 8 receives the file data transmission request information.

Next, the storing/reading processing unit 89 of the schedule management server 8 searches the event management DB 8005 (FIG. 14B), using the scheduled event ID and the application ID received at S58 as a search key, to obtain file data associated with the scheduled event ID and the application ID (S59). The transmission/reception unit 81 transmits the file data read at S59 to the sharing assistant server 6 (S60). Accordingly, the transmission/reception unit 61 of the sharing assistant server 6 receives the file data.

Next, the storing/reading processing unit 69 of the sharing assistant server 6 stores, in the schedule management DB 6003 (FIG. 11C), the file data received at S60, in association with the scheduled event ID received at S54, the conducted event ID generated at S55, and the application ID received at S41 (S61).

The transmission/reception unit 61 transmits the conducted event ID generated at S55 and the file data received at S60, to the electronic whiteboard 2 (S62). Accordingly, the transmission/reception unit 21A of the activation control unit 20A of the electronic whiteboard 2 receives the conducted event ID and the file data.

Next, at the electronic whiteboard 2, the storing/reading processing unit 29A of the activation control unit 20A stores the conducted event ID and the file data received at S62, and the application ID read out at S40 in the storage unit 2000, in association (S63). The file data transmitted from the sharing assistant server 6 is stored in a specific storage area of the storage unit 2000. The electronic whiteboard 2 accesses the specific storage area to read the file data, and the display control unit 24B of the event control unit 20B controls the display 220 to display an image based on the file data during the event.

The display control unit 24A of the activation control unit 20A controls the display 220 to display an event information screen 250 for the selected event as illustrated in FIG. 27 (S64). The event information screen 250 includes, the application name of the external application 103 selected at S39, a display area 251 for an event name, a display area 252 for a scheduled event time (scheduled start time and scheduled event time), and a display area 253 for a reservation holder name. The event information screen 250 further includes a display area 256 for memo, a display area 257 for names of registered participants, and a display area 258 for displaying identification information (such as a file name) of file data stored in the specific storage area in the storage unit 2000. The display area 257 displays the name of the reservation holder, and the name of each participant, which are entered through the screen of FIG. 20. The display area 257 further displays a check box to be marked to indicate whether the corresponding participant actually participate in the event (meeting). The display area 258 further displays a name of file data stored in the specific storage area of the storage unit 2000. Specifically, the display area 258 displays a file name of file data that has been downloaded from the sharing assistant server 6 or being downloaded from the sharing assistant server 6. The event information screen 250 further includes a “CLOSE” button 259 to be pressed to close the event information screen 250, at its lower right.

After the user puts a mark(s) in the checkbox(s) corresponding to one or more participants who are actually participating in the event (meeting) among the scheduled (registered) participants and then presses the “CLOSE” button 259, the acceptance unit 22A of the activation control unit 20A accepts selection of the one or more participants (S65). The transmission/reception unit 21A of the activation control unit 20A transmits, to the sharing assistant server 6, the user ID of each participant and participation (presence) of each participant (S66). Accordingly, the transmission/reception unit 61 of the sharing assistant server 6 receives the user ID and participation of each participant.

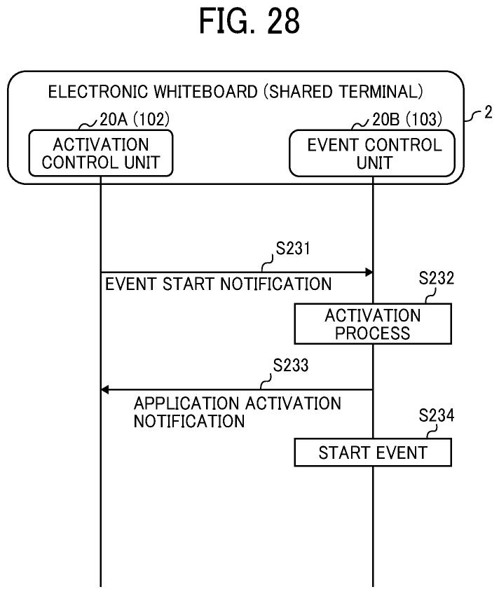

At the sharing assistant server 6, the storing/reading processing unit 69 enters information on participation, in the “participation” field, in which no information was entered, in the schedule management table (FIG. 11C) in the schedule management DB 6003 (S67). As described above, the user A starts an event (a meeting on a strategy, in this example) to be executed by the external application 103, using the resource (the conference room X, in this example) and the Launcher 102 installed on the shared terminal (the electronic whiteboard 2 located in the conference room X, in this example). Referring to FIG. 28, processing to activate the external application 103 from the Launcher 102 is described according to an embodiment. FIG. 28 is a sequence diagram illustrating operation of controlling processing to activate the external application 103.

First, the application communication unit 27A of the activation control unit 20A transmits an event start notification for starting an event to be started by the processing described above with reference to FIG. 21A to FIG. 27 to the event control unit 20B corresponding to the application ID read out at S40 (S231). The event start notification includes the event information 235 selected at S51, and the conducted event ID and the file data received at S62. A set of the event information 235 selected by the process of step S51 and the conducted event ID and the file data received by the process of S62 is an example of to-be-conducted event information. Accordingly, the application communication unit 27B of the event control unit 20B receives the event start notification.

In response to receiving the event start notification at the application communication unit 27B, the activation processing unit 28B of the event control unit 20B activates the meeting assistant application 103a, which is an example of the external application 103 (S232). When the activation processing unit 28B of the event control unit 20B activates the meeting assistant application 103a, the application communication unit 27B transmits an application activation notification to the activation control unit 20A (S233). The application activation notification includes the application ID of the external application 103 activated by the activation processing unit 28B (in this example, the application ID of the meeting assistant application 103a; app001). Accordingly, the application communication unit 27A of the activation control unit 20A receives the application activation notification.

Next, the event control unit 20B starts an event indicated by the event start notification received at S231 (S234). In this case, the event control unit 20B starts the event indicated by the to-be-conducted event by using the to-be-conducted event information included in the event start notification received at S231. Specifically, as illustrated in FIG. 29, the user A uses the electronic whiteboard 2 to carry out a meeting in the conference room X. The display control unit 24B of the event control unit 20B controls the display 220 to display an on-going-event screen R. The display control unit 24B of the event control unit 20B further displays, at an upper right portion of the on-going-event screen R, the remaining time during which the resource (in this example, the conference room X) can be used. In this embodiment, the display control unit 24B of the event control unit 20B calculates a time period between the current time and the scheduled end time indicated by the event information included in the event start notification received at S231, and displays the calculated time period as the remaining time.

The display control unit 24B of the event control unit 20B further displays an icon r1 to be pressed to register an action item, an icon r2 to be pressed to view a conducted event record, and an icon r3 to be pressed to view a material file (meeting materials) stored in the specific storage area of the storage unit 2000. The display control unit 24B further displays, on the on-going-event screen R, an image r4 based on the file data of meeting materials. The icon r3 is an example of a selectable image, which is selected to display an image based on the file data stored in the specific storage area. For example, when the user of the electronic whiteboard 2 presses the icon r3, the acceptance unit 22B of the event control unit 20B receives a selection of the icon r3. The display control unit 24B then controls the display 220 to display an image r4 based on the file data of meeting materials, which is stored in the specific storage area of the storage unit 2000.

As described above, a user uses the electronic whiteboard 2 to conduct a desired event from the events registered in the schedule management server 8 by causing the Launcher 102 and the external application 103 to operate in cooperation with each other. Thus, even when the Launcher 102 installed on the electronic whiteboard 2 is a desired launcher application selected in view of convenience or ease of operation, the electronic whiteboard controls the Launcher 102 and the external application 103 to communicate the to-be-conducted event information to assist the user to carry out the event corresponding to the to-be-conducted event information using the electronic whiteboard. In other words, the user of the electronic whiteboard 2 can perform an operation of carrying out an event using the Launcher 102 that he/she wants to use.

Registration of Event Record:

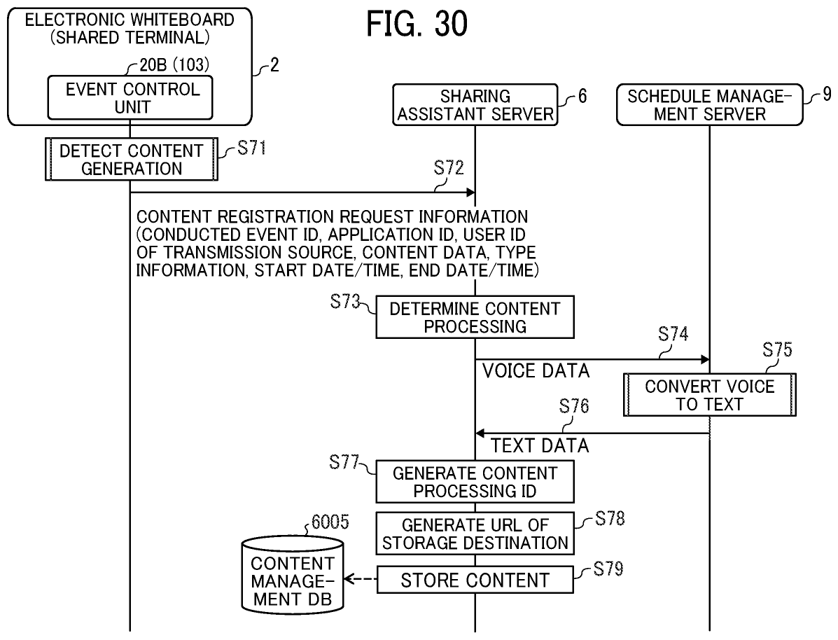

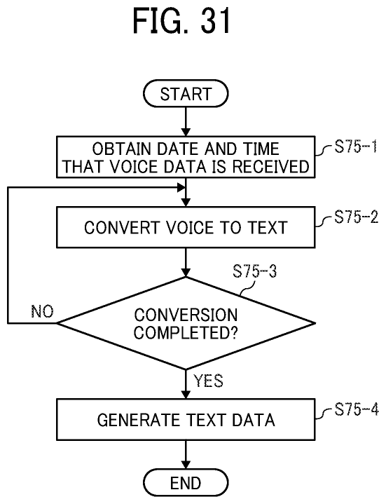

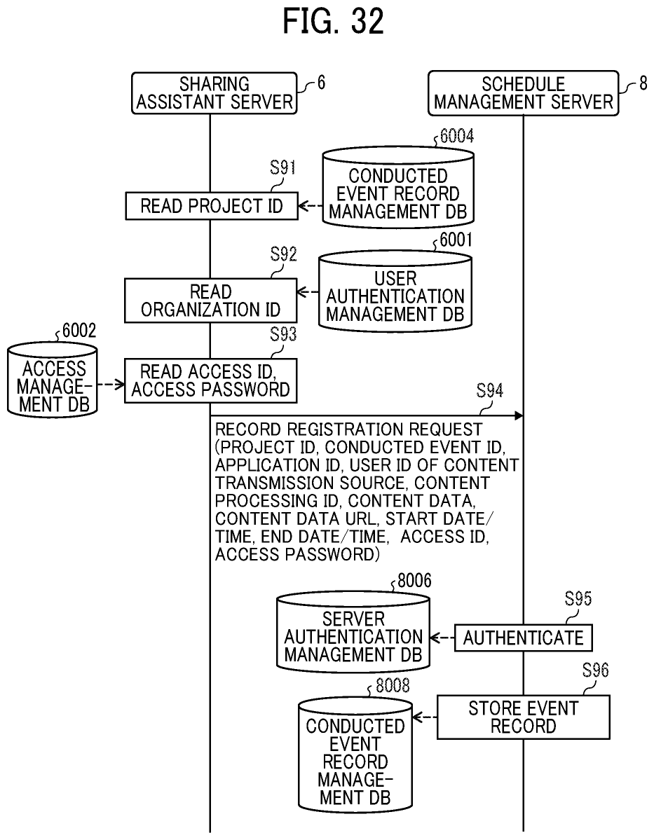

Referring now to FIG. 30 to FIG. 36, processing to register an event record is described according to an embodiment. FIG. 30 and FIG. 32 are sequence diagrams illustrating operation of registering a record of the event that has been started, according to an embodiment. FIG. 31 is a flowchart illustrating operation of converting voice data to text data, according to an embodiment.

The determination unit 25B of the event control unit 20B of the electronic whiteboard 2 detects content generation. Specifically, the determination unit 25B determines a type of content processing being performed during the event that has been started (S71). For example, when the content is voice data generated through recording by the image/audio processing unit 23B of the event control unit 20B, the determination unit 25B determines a type of content processing as “recording”. In another example, when the content is image data obtained through screenshot (capturing) by the image/audio processing unit 23B, the determination unit 25B determines that a type of content processing is “screenshot”. In another example, when the content is file data of meeting materials, which is transmitted by the transmission/reception unit 21B, the determination unit 25B determines a type of content processing is “file transmission”.

Next, the transmission/reception unit 21B of the event control unit 20B transmits content registration request information indicating a request for registering the content being generated, to the sharing assistant server 6 (S72). In this example, the transmission/reception unit 21B automatically transmits the content registration request information, every time generation of the content is detected. The content registration request information includes the conducted event ID, the application ID, the user ID of a transmission source of the content, content data, and content processing type (recording, screenshot, file transmission). The content registration request information further includes information on the start date/time and end date/time of content processing. Accordingly, the transmission/reception unit 61 of the sharing assistant server 6 receives the content registration request information.

The determination unit 65 of the sharing assistant server 6 determines a type of content processing, based on the content processing type in the content registration request information that is received at the transmission/reception unit 61 (S73). In one example, when the determination unit 65 determines that the content processing type is “recording”, the transmission/reception unit 61 of the sharing assistant server 6 transmits the voice data, which is received as content data, to the voice-to-text conversion server 9 (S74). Accordingly, the transmission/reception unit 91 of the voice-to-text conversion server 9 receives the voice data. When the content type processing is other than “recording”, the operation proceeds to S77 without performing S74 to S76.

The conversion unit 93 of the voice-to-text conversion server 9 converts the voice data received at the transmission/reception unit 91 to text data (S75). Referring to FIG. 31, processing of voice-to-text conversion, performed by the voice-to-text conversion server 9, is described according to an embodiment. The conversion unit 93 obtains information indicating date and time when the voice data is received at the transmission/reception unit 91 (S75-1). The information obtained at S75-1 may indicate the date and time when the sharing assistant server 6 receives the voice data at S72, or the date and time when the sharing assistant server 6 sends the voice data at S74. In this example, the transmission/reception unit 91 of the voice-to-text conversion server 9 receives, at S74, the voice data and the above-described information on the date and time from the sharing assistant server 6.

Next, the conversion unit 93 converts the voice data, received at the transmission/reception unit 91, to text data (S75-2). When it is determined that the conversion of the voice data to text data is completed (“YES” at S75-3), the operation proceeds to S75-4. By contrast, when it is determined that the conversion of the voice data to text data is not completed (“NO” at S75-3), the operation repeats S75-2. The conversion unit 93 generates text data, as a result of the voice-to-text conversion (S75-4). As described above, the voice-to-text conversion server 9 converts the voice data transmitted from the sharing assistant server 6 into text data. The voice-to-text conversion server 9 repeatedly performs operation of FIG. 31, every time the voice data is received from the sharing assistant server 6.

Referring again to FIG. 30, description of registration of the event record continues. The transmission/reception unit 91 transmits the text data converted by the conversion unit 93, to the sharing assistant server 6 (S76). With the text data, the transmission/reception unit 91 transmits the information indicating the date and time that the voice data is received, which is obtained at S75-1, to the sharing assistant server 6. In one example, with the text data, the transmission/reception unit 91 transmits information indicating the date and time that the text data is generated by the conversion unit 93, to the sharing assistant server 6. Accordingly, the transmission/reception unit 61 of the sharing assistant server 6 receives the text data.

The generation unit 64 generates a content processing ID for identifying the content processing, which is detected during the event (S77). The generation unit 64 further generates a URL of content data being generated (S78). The storing/reading processing unit 69 stores, in the content management DB 6005 (FIG. 12B), the content processing type, the start date and time of content processing, the end date and time of content processing, the content processing ID generated at S77, and the URL indicating the storage destination of the content data generated at S78, for the set of the conducted event ID and the application ID that is received at S72 (S79). In one example, when the content processing type is “voice text reception”, the start date and time and the end date and time of the content processing is the information indicating the date end time that is received at S76. In another example, when the content processing type is “voice text reception” the start date and time and the end date and time of the content processing is information indicating the date and time when the sharing assistant server 6 receives the text data at S76.

The operation now proceeds to S91 of FIG. 32. The storing/reading processing unit 69 of the sharing assistant server 6 searches the conducted event management DB 6004 (FIG. 12A) using the conducted event ID received at S72 as a search key, to obtain corresponding project ID (S91). The storing/reading processing unit 69 searches the user authentication management DB 6001 (FIG. 11A) using the user ID of the content transmission source as a search key, to obtain the corresponding organization ID (S92).

The storing/reading processing unit 69 searches the access management DB 6002 (FIG. 11B) using the organization ID read at S92 as a search key to obtain the access ID and access password that correspond to the organization ID obtained at S92 (S93).

Next, the transmission/reception unit 61 transmits record registration request information indicating a request for registering an event record, to the schedule management server 8 (S94). The record registration request includes the project ID read at S91, and the conducted event ID, the application ID, the user ID of the content transmission source, the content data, the start date and time of content processing, and the end date and time of content processing, which are received at S 72. The record registration request further includes the content processing ID generated at S77, the URL of content data generated at S78, and the access ID and password read at S93. The transmission/reception unit 81 of the schedule management server 8 receives the record registration request.

Next, the authentication unit 82 of the schedule management server 8 authenticates the sharing assistant server 6 using the access ID and the access password (S95). Since the authentication processing of S95 is substantially the same as described above referring to S36, description thereof is omitted. The following describes the case where the authentication result indicates that authentication is successful.

The storing/reading processing unit 89 stores various types of data or information, received at S94, in the conducted event record management DB 8008 (FIG. 16A) (S96). Specifically, the storing/reading processing unit 89 stores, in the conducted event record management DB 8008, various data (or information) including information on the file data processor, in association with a set of the project ID, the conducted event ID, and the application ID received at S94. Accordingly, the schedule management server 8 is able to manage information regarding the content, in a substantially similar manner as the sharing assistant server 6 manages the content.

As described above, the electronic whiteboard 2 transmits the event ID of an event related to a particular project, and any content that is generated during the event, to the schedule management server 8. The schedule management server 8 stores, for each conducted event ID associated with the project ID, information on the content in the conducted event record management DB 8008. That is, the sharing system 1 allows a user to designate information indicating association between the event that has been started and the project, whereby content data generated during the event can be stored for each project.

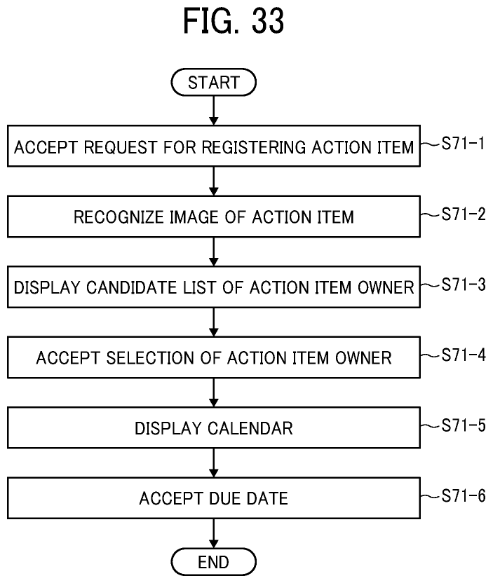

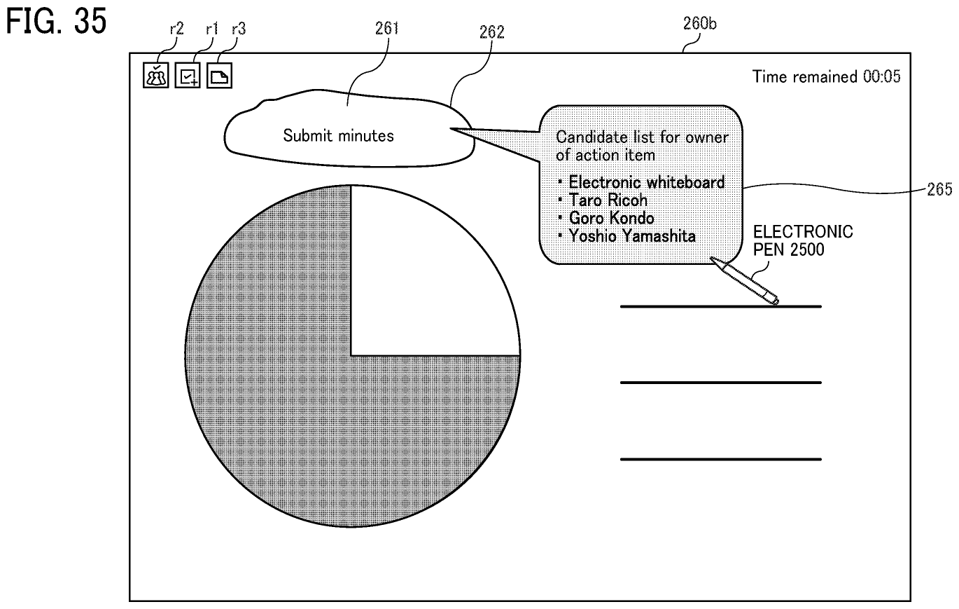

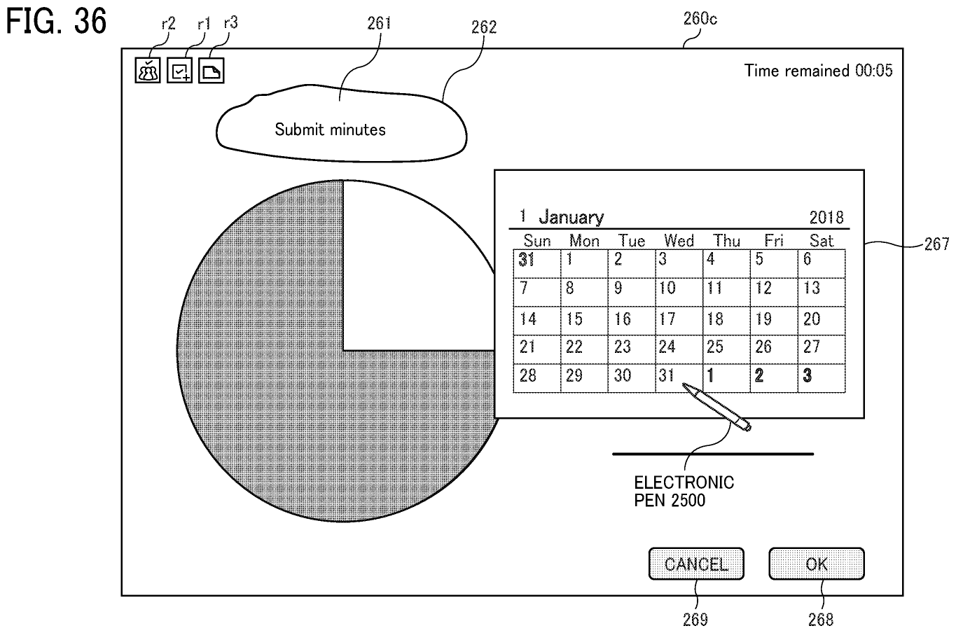

Registration of Action Item: Referring now to FIG. 33 to FIG. 36, operation of processing an action item, as an example of content, is described according to an embodiment. FIG. 33 is a flowchart illustrating operation of registering an action item, according to an embodiment. FIG. 34 is an illustration of an example screen in which an action item is designated. FIG. 35 is an illustration of an example screen including a list of candidates of owner of the action item. FIG. 36 is an illustration of an example screen including a calendar for selecting the due date of the action item.

Referring to FIG. 33, as the user presses the icon r1, the acceptance unit 22B of the event control unit 20B receives a request for registering an action item (S71-1). As illustrated in FIG. 34, it is assumed that the user writes an action item (“Submit minutes”) on a drawing screen 260a of the electronic whiteboard 2 using the electronic pen 2500, and circles the drawing image 261. In such case, the electronic whiteboard 2 recognizes the circled area as a designated area 262, which includes a drawing image 261. The acceptance unit 22B accepts input of the designated area 262 including the drawing image 261. The identifying unit 26B identifies the drawing image 261, included in the designated area 262, as an image of the action item (S71-2). The description given above with reference to FIG. 34 is of an example in which the identifying unit 26B identifies the drawing image 261, which is circled by the line of the designated area 262. Alternatively, the identifying unit 26B may identify the drawing image 261, which is determined by a line that is apart from the designated area 262 at a predetermined distance. As described above, the designated area 262 may be determined based on the user's drawing of a certain figure, such as a circle or a polygon, with the electronic pen 2500.

Next, as illustrated in FIG. 35, the display control unit 24B displays a candidate list 265, which lists candidates of an owner of the action item, on the drawing screen 260b (S71-3). As the user selects a particular name from the candidate list 265 with the electronic pen 2500, the acceptance unit 22B receives a selection of the owner of the action item (S71-4). The user names to be displayed in the candidate list 265 may be obtained from the names of participants, or from the project members.

Next, as illustrated in FIG. 36, the display control unit 24B displays, on the drawing image 260c, a calendar 267 for receiving a selection of a particular date (S71-5). As the user selects a particular date from the calendar 267 with the electronic pen 2500, the acceptance unit 22B accepts a selection of the due date for the action item (S71-6). The calendar 267 is an example of a due date input screen. The due date input screen may be a list of dates, without indication of a day.

After the above-described operation, the electronic whiteboard 2 sends content registration request information, which requests to register the action item, to the sharing assistant server 6. The content registration request information includes a conducted event ID for identifying the event in which the action item is generated, a user ID of the owner of the action item that is selected at S71-4, image data of the action item (in this case, “Submit minutes”) identified at S71-2, and the due date of the action item accepted at S71-6. As an example of content, the transmission/reception unit 21B transmits image data in the designated area as image data representing the action item generated in that event. Accordingly, the transmission/reception unit 61 of the sharing assistant server 6 receives the content registration request information. The processing to be performed after the sharing assistant server 6 receives the content registration request information is substantially the same as the processing described above referring to FIG. 30 and FIG. 32, such that description thereof is omitted.

Processing to End Event:

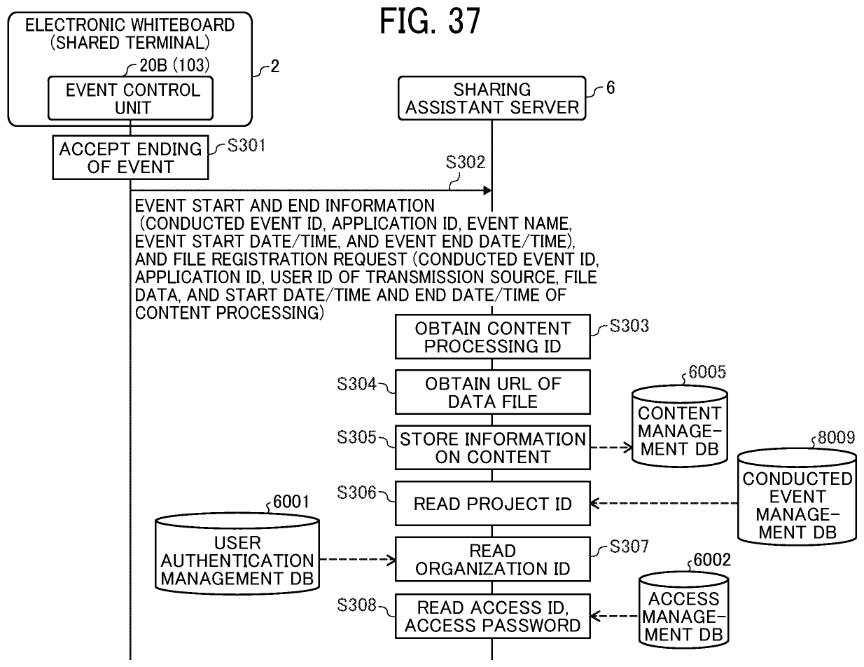

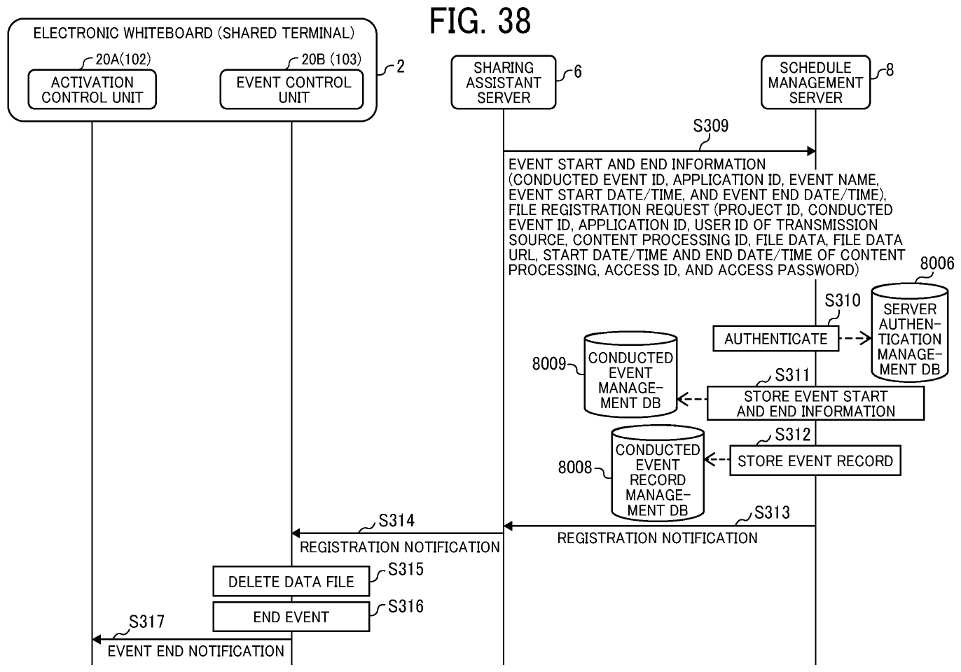

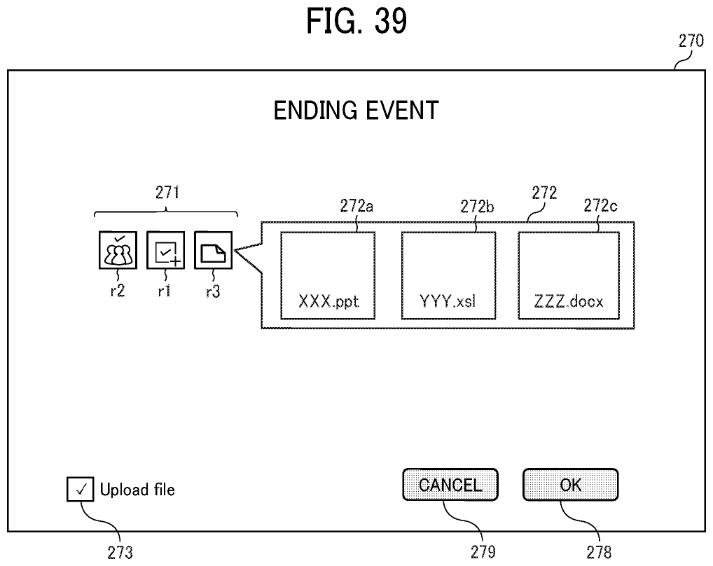

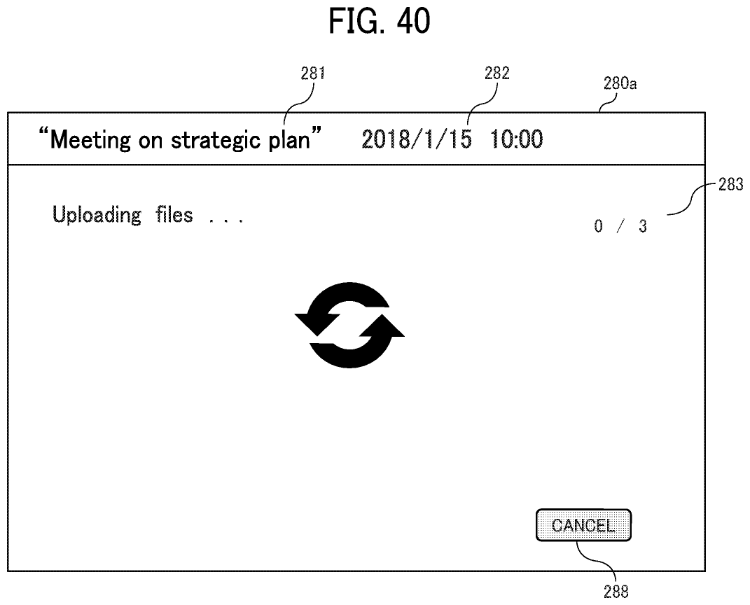

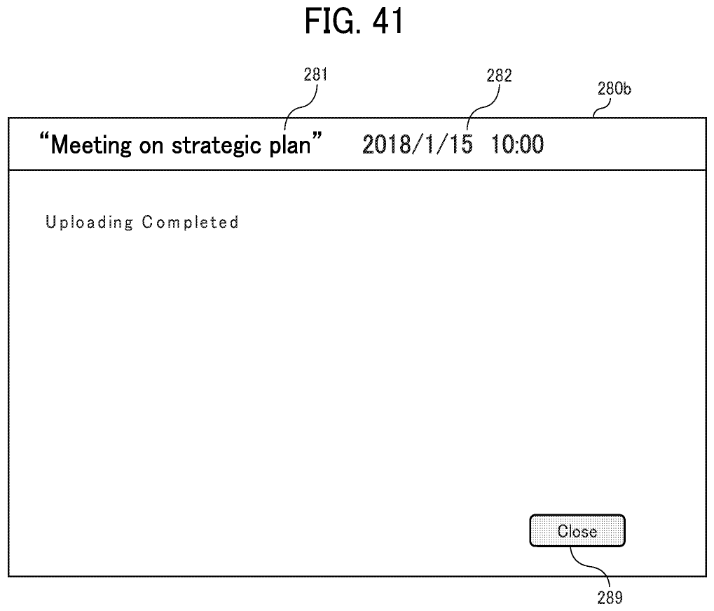

Next, referring to FIG. 37 to FIG. 41, operation of controlling processing to end an event being conducted, is described according to an embodiment. FIG. 37 and FIG. 38 are sequence diagrams illustrating operation of controlling processing to end an event, according to the embodiment. FIG. 39 is an illustration of an example of an event end screen, displayed by the electronic whiteboard 2. FIG. 40 is an illustration of an example of a file data uploading screen, displayed by the electronic whiteboard 2. FIG. 41 is an illustration of an example of a file data uploading completion screen, displayed by the electronic whiteboard 2.

In response to a user instruction to close the on-going-event screen R being displayed on the display 220 (see FIG. 29), the acceptance unit 22B of the event control unit 20B accepts an instruction to end the event being conducted (S301).

The transmission/reception unit 21B of the event control unit 20B transmits, to the sharing assistant server 6, event start and end information, and file data registration request information indicating a request for registering file data (S302). The event start and end information includes the conducted event ID, the application ID, the event name, the event start date and time, and the event end date and time. The file data registration request information includes the conducted event ID, the user ID of a transmission source, the file data, the start date and time of content processing, and the end date and time of content processing. The transmission/reception unit 61 of the sharing assistant server 6 receives the event start and end information, and the file data registration request information.

The generation unit 64 of the sharing assistant server 6 generates, for each content that has been generated during the event, a content processing ID identifying the content. (S303). The generation unit 64 further generates a URL of content data that has been generated during the event (S304). The storing/reading processing unit 69 stores, in the content management DB 6005 (FIG. 12B), the content processing type, the start date and time of content processing, the end date and time of content processing, the content processing ID generated at S303, and the URL of the content data generated at S304, for the set of the conducted event ID and the application ID that is received at S302 (S305).

The storing/reading processing unit 69 of the sharing assistant server 6 searches the conducted event management DB 6004 (FIG. 12A) using the conducted event ID received at S302 as a search key, to obtain the corresponding project ID (S306). The storing/reading processing unit 69 searches the user authentication management DB 6001 (FIG. 11A) using the user ID of the content transmission source as a search key, to obtain the corresponding organization ID (S307).

The storing/reading processing unit 69 searches the access management DB 6002 (FIG. 11B) using the organization ID read at S92 as a search key to obtain the corresponding access ID and access password (S308).

Next, referring to FIG. 38, the transmission/reception unit 61 transmits, to the schedule management server 8, the event start and end information and the file data registration request information indicating a request for registering file data (S309) received at S302. The file data registration request information includes the project ID read at S306, the conducted event ID, the application ID, the user ID of a transmission source, the file data, the start date and time of content processing, and the end date and time of content processing (received at S302), the content processing ID generated at S303, the URL of file data generated at S304, and the access ID and password read at S308. The transmission/reception unit 81 of the schedule management server 8 receives the event start and end information, and the file data registration request information.

Next, the authentication unit 82 of the schedule management server 8 authenticates the sharing assistant server 6 using the access ID and the access password (S310). Since the authentication processing of S310 is substantially the same as described above referring to S36, description thereof is omitted. The following describes the case where the authentication result indicates that authentication is successful.

Next, the storing/reading processing unit 89 of the schedule management server 8 stores, in the conducted event management DB 8009 (FIG. 16B), the event start and end information received at S309 (S311). Specifically, the storing/reading processing unit 89 adds one record of event start and end information, to the conducted event management table in the conducted event management DB 8009.

The storing/reading processing unit 89 stores various types of data or information, received at S309, in the conducted event record management DB 8008 (FIG. 16A) (S312). Specifically, the storing/reading processing unit 89 stores, in the conducted event record management DB 8008, various data (or information) including information on the file data, in association with the project ID, the conducted event ID, and the application ID received at S309. Accordingly, the schedule management server 8 is able to manage information regarding the file data, in a substantially similar manner as the sharing assistant server 6 manages the file data.

Next, the transmission/reception unit 81 transmits file data registration information indicating that the file data is registered, to the sharing assistant server 6 (S313). Accordingly, the transmission/reception unit 61 of the sharing assistant server 6 receives the file data registration information.

The transmission/reception unit 61 of the sharing assistant server 6 transmits the file data registration information received from the schedule management server 8, to the electronic whiteboard 2 (S314). Accordingly, the transmission/reception unit 21B of the event control unit 20B of the electronic whiteboard 2 receives the file data registration information.

In response to receiving the file data registration information notification at the transmission/reception unit 21B, the storing/reading processing unit 29B of the event control unit 20B deletes the file data, which has been registered, from the specific storage area of the storage unit 2000 (S315). Since the file data that has been transmitted to the sharing assistant server 6 is deleted from the electronic whiteboard 2, the risk of leakage of confidential information that might have been shared during the meeting can be reduced.

The event control unit 20B ends the event being conducted (S316). Specifically, the event control unit 20B closes the on-going-event screen R displayed on the display 220 by the display control unit 24B, and stops the external application 103 (in this example, the meeting assistant application 103a). The application communication unit 27B of the event control unit 20B transmits an event end notification to the activation control unit 20A (S317). The event end notification includes the application ID of the external application 103 (in this example, the application ID of the meeting assistant application 103a; app001). Accordingly, the application communication unit 27A of the activation control unit 20A receives the event end notification. The activation control unit 20A may stop the Launcher 102 in response to receiving the event end notification at the application communication unit 27A.

The following describes transitions of screen displayed by the electronic whiteboard 2, when controlling processing to end the event. In response to acceptance of an instruction to end the on-going event by the acceptance unit 22B of the event control unit 20B at 5301, the display control unit 24B controls the display 220 to display an event end screen 270 as illustrated in FIG. 39. The event end screen 270 includes a tool bar 271, a file display area 272, a file uploading selection area 273, a “OK” button 278 to be pressed to end the event, and a “CANCEL” button 279 to be pressed to cancel processing to end the event. The tool bar 271 includes graphical images such as icons r1, r2 and r3, which are similar to the icons illustrated in FIG. 29. The file display area 272 includes file data images 272a, 272b and 272c, each being used for identifying file data stored in a specific storage area of the storage unit 2000. The file uploading selection area 273 includes a check box for selecting whether or not the file data represented by the data file image, displayed in the file display area 272, is to be uploaded to the sharing assistant server 6.

When the acceptance unit 22B accepts selection of the “OK” button 278 after the file uploading selection area 273 is selected, the display control unit 24B controls the display 220 to display a file uploading screen 280a as illustrated in FIG. 40. That is, the file uploading screen 280a is displayed on the display 220, when the file data stored in the specific storage area of the storage unit 2000 is being uploaded to the sharing assistant server 6. The file uploading screen 280a includes an event name 281 of the event to end, the event end date and time 282, a display area 283 for displaying the progress in updating the file data, and a “CANCEL” button 288 for interrupting (or cancelling) uploading of the file data. The display area 283 indicates a number of file data items to be updated (“3” in FIG. 40), and a number of file data items that have been uploaded (“0” in FIG. 40).

When uploading of the file data is completed, the display control unit 24B controls the display 220 to display an uploading completion screen 280b illustrated in FIG. 41. The uploading completion screen 280b includes a “Close” button 289 to be pressed to end the event. When the uploading completion screen 280b is displayed on the display 220, as described above referring to 5315, the storing/reading processing unit 29B of the event control unit 20B deletes the file data, which has been uploaded, from the specific storage area of the storage unit 2000.

On the other hand, when uploading of any file data item fails, during when the file uploading screen 280a is being displayed on the display 220, the display control unit 24B displays information for identifying the file data that uploading has failed (such as the file name). For example, if uploading of file data has failed due to a trouble in the communication network 10, the user participating in the event may print any file data that has been generated or edited during the event, or store such data file in the USB memory 2600 connected to the electronic whiteboard 2.

When the file data is kept stored in the specific storage area of the storage unit 2000 even after the event ends, the storing/reading processing unit 29A of the activation control unit 20A can delete the file data stored in the specific storage area, before or at the time of starting a next event for the electronic whiteboard 2. Since the data file that is kept stored can be deleted from the electronic whiteboard 2, the risk of leakage of confidential information that might have been shared during the meeting can be reduced.

According to one or more embodiments, as illustrated in FIG. 21A and FIG. 21B to FIG. 29, the electronic whiteboard 2 is one example of a shared terminal communicable with the schedule management server 8 (an example of a management system) configured to manage content data generated in relation to the event conducted using the external application 103 (an example of a first application).

The electronic whiteboard 2 includes an acceptance unit 22A (an example of receiving means) configured to receive, by the Launcher 102 (an example of a second application) that is configured to activate any external application 103, a selection of a particular external application 103 (an example of a particular first application) that operates to conduct a particular event, an application communication unit 27A (an example of notification means) configured to send a request for starting the particular event to the particular external application 103 from the Launcher 102, an activation processing unit 28B (an example of event execution means) that controls the particular external application 103 to start the particular event corresponding to the event start request that is sent by the application communication unit 27A. Thus, the electronic whiteboard 2 can execute an event by controlling a plurality of applications installed on the electronic whiteboard to operate in cooperation with one another. In addition, since the electronic whiteboard 2 can execute an event by controlling a desired launcher application to operate in cooperation with the external application 103, a user of the electronic whiteboard 2 can use services or functions provided by the sharing system by using a launcher application that is easy operate using the launcher application that is convenient in view of the user's operability.

Further, according to one or more embodiments, as illustrated in FIG. 21A and FIG. 21B to FIG. 29, in the electronic whiteboard 2 (an example of a shared terminal), the display control unit 24A (an example of first display control means) controls the display 220 (an example of a display unit) to display the application selection screen 150 (an example of an application selection screen) by the Launcher 102 (an example of the second application), the application selection screen receiving a selection of the particular external application 103 (an example of the particular first application), and the application communication unit 27A (an example of a notification sending means) sends an event start request to the particular external application 103 selected on the application selection screen 150. Thus, the electronic whiteboard 2 selects, by the Launcher 102, the particular external application 103 to be activated from the external applications 103 installed on the electronic whiteboard 2, to execute an event in cooperation with a desired external application 103.

Furthermore, according to one or more embodiments, as illustrated in FIG. 21A and FIG. 21B to FIG. 29, in the electronic whiteboard 2 (an example of the shared terminal), the transmission/reception unit 21A (an example of first receiving means) receives, by the Launcher 102 (an example of the second application), to-be-conducted event information related to the particular event from the schedule management server 8 (an example of the management system), and the application communication unit 27A (an example of the notification sending means) sends, by the Launcher 102, the event start request including the received to-be-conducted event information, to the particular external application 103 (an example of the particular first application). Thus, the electronic whiteboard 2 sends to the external application 103 the to-be-conducted event information acquired by the launcher 102, to execute an event designated by the Launcher 102 by using the external application 103.

Applications installed in shared terminals such as electronic whiteboards often have different launcher functions according to a user who uses the shared terminal and uses. In this case, an application used for conducting an event such as a meeting is required to be linked with an application having a launcher function. However, in the related art, cooperation between a plurality of applications is not taken into consideration.

According to one or more embodiments of the present disclosure, an event is conducted with a plurality of applications provided in a shared terminal linked with one another.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), system on a chip (SOC), graphics processing unit (GPU), and conventional circuit components arranged to perform the recited functions.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

What is claimed is:

1. A shared terminal communicable with a management system configured to manage content data generated in relation to an event, the shared terminal comprising:
a memory that stores one or more first applications, and a second application that activates the one or more first applications; and
circuitry configured to:
execute the second application to,
receive selection of a particular first application of the one or more first applications, the particular first application being configured to perform processing to conduct a particular event, and
send an event start request requesting to start the particular event to the particular first application; and
execute the particular first application to perform processing to start the particular event identified by the event start request sent from the second application.

2. The shared terminal of claim 1,
wherein the second application configures the circuitry to control a display of the shared terminal to display an application selection screen on which selection of the particular first application is received,
wherein the particular first application is selected on the application selection screen.

3. The shared terminal of claim 1, wherein
the second application configures the circuitry to receive to-be-conducted event information related to the particular event from the management system,
wherein the event start request includes the received to-be-conducted event information.

4. The shared terminal of claim 3, wherein
the second application configures the circuitry to:
control a display of the shared terminal to display an event selection screen through which selection of the particular event is received; and
receive, from the management system, the to-be-conducted event information related to the particular event selected on the event selection screen.

5. The shared terminal of claim 1, wherein
the particular first application configures the circuitry to:
generate particular content data relating to content generated during the particular event started by the particular first application; and
transmit the generated particular content data to the management system.

6. The shared terminal of claim 5, wherein
the particular first application configures the circuitry to control a display of the shared terminal to display the generated particular content data.

7. The shared terminal of claim 1, wherein
the second application is a launcher application that operates on an operating system, and
each of the one or more first applications is an application activated in response to a request from the launcher application.

8. A sharing system comprising:
the shared terminal of claim 1; and
a management system including circuitry to:
transmit to-be-conducted event information relating to a particular event to the shared terminal;
receive, from the shared terminal, particular content data generated during the particular event; and
store the to-be-conducted event information and the particular content data in association with each other.

9. A method of assisting content sharing processing, performed by a shared terminal installed with one or more first applications and a second application, the shared terminal being communicable with a management system configured to manage content data generated in relation to an event, the method comprising:
executing the second application to receive selection of a particular first application of the one or more first applications, the particular first application being configured to control processing to conduct a particular event;
executing the second application to send an event start request for starting the particular event to the particular first application; and
executing the particular first application to perform control processing to start the particular event indicated by the event start request.

10. The method of claim 9, further comprising:
executing the second application to control a display of the shared terminal to display an application selection screen on which selection of the particular first application is received,
wherein the particular first application is selected on the application selection screen.

11. The method of claim 9, further comprising:
executing the second application to receive to-be-conducted event information related to the particular event from the management system,
wherein the event start request includes the received to-be-conducted event information.

12. The method of claim 11, further comprising:
executing the second application to,
control a display of the shared terminal to display an event selection screen through which selection of the particular event is received, and
receive, from the management system, the to-be-conducted event information related to the particular event selected on the event selection screen.

13. The method of claim 9, further comprising:
executing the particular first application to,
generate particular content data relating to content generated during the particular event started by the particular first application, and
transmit the generated particular content data to the management system.

14. The method of claim 13, further comprising:
executing the particular first application to control a display of the shared terminal to display the generated particular content data.

15. The method of claim 9, wherein
the second application is a launcher application that operates on an operating system, and
each of the one or more first applications is an application activated in response to a request from the launcher application.

16. A non-transitory computer-readable medium storing a program that causes a computer to execute the method of claim 9.
